(19) United States
(12) Patent Application Publication
(10) Pub. No.: US 2023/0331232 A1
(43) Pub. Date: Oct. 19, 2023

(54) CONTROL CALCULATION APPARATUS

(71) Applicant: Mitsubishi Electric Corporation, Tokyo (JP)

(72) Inventors: Kenta TOMINAGA, Tokyo (JP); Tomoki UNO, Tokyo (JP); Yuko OMAGARI, Tokyo (JP); Ryota OKAMOTO, Tokyo (JP)

(73) Assignee: Mitsubishi Electric Corporation, Tokyo (JP)

(21) Appl. No.: 18/159,829

(22) Filed: Jan. 26, 2023

(30) Foreign Application Priority Data
Apr. 15, 2022 (JP) 2022-067494

(51) Int. Cl. B60W 30/18

(52) U.S. Cl. CPC B60W 30/18163; B60W 2552/10; B60W 2710/20; B60W 2710/06; B60W 2710/08

(57) ABSTRACT

To provide a control calculation apparatus which can generate the target trajectory according to the state of deviating, and can suppress that the riding comfort is deteriorated, even if the vehicle deviates from the initial trajectory for the lane change due to disturbance, such as the override. A control calculation apparatus calculates a target value of vehicle control variable, which includes at least a steering angle, for the own vehicle to travel along the target trajectory, based on the traveling state and the target trajectory; and after the generation start of the target trajectory for the lane change, generates the target trajectory for the lane change which passes through a position within a prescribed distance range from the current position of the own vehicle detected based on the traveling state.

### INCORPORATION BY REFERENCE

The disclosure of Japanese Patent Application No. 2022-67494 filed on Apr. 15, 2022 including its specification, claims and drawings, is incorporated herein by reference in its entirety.

### BACKGROUND

This present disclosure is related with a control calculation apparatus.

The technology of performing the traveling control of the vehicle is proposed variously. As one of them, the technology for performing the lane change automatically has been developed. For example, in the controller of WO 2017/047261 A, the virtual lane for moving to the adjacent lane from the current lane is generated, the virtual lane is set as the target trajectory, and the own vehicle is controlled to follow the target trajectory.

### SUMMARY

In the controller of WO 2017/047261 A, after the generation start of the target trajectory for the lane change, when a handle operation (override) by the driver is performed, or when a steering for avoiding the entrance-forbidden area, such as the obstacle, is performed, or when the error of vehicle control occurs, the own vehicle may deviate from the initial target trajectory for the lane change. For example, after the end of the override, the own vehicle tries to follow the target trajectory for the lane change forcibly, operation becomes rapid, and the riding comfort is deteriorated. In this way, if the initial target trajectory is not changed, and the own vehicle continues automatic driving of the lane change in a state of deviating from the initial target trajectory, the vehicle control variable becomes excessive, and the traveling trajectory changes. Ideal lane change cannot be performed, and the riding comfort may be deteriorated.

Then, the purpose of the present disclosure is to provide a control calculation apparatus which can generate the target trajectory according to the state of deviating, and can suppress that the riding comfort is deteriorated, even if the own vehicle deviates from the initial target trajectory for the lane change due to disturbance, such as the override.

A control calculation apparatus according to the present disclosure, including:
a traveling state acquisition unit that acquires a traveling state of an own vehicle;
a target trajectory generation unit that generates a target trajectory of the own vehicle; and
a control variable calculation unit that calculates a target value of a vehicle control variable, which includes at least a steering angle, for the own vehicle to travel along the target trajectory, based on the traveling state and the target trajectory,
wherein, after generation start of the target trajectory for a lane change, the target trajectory generation unit generates the target trajectory for the lane change which passes through a position within a prescribed distance range from a current position of the own vehicle detected based on the traveling state.

According to the control calculation apparatus of the present disclosure, after the start of the lane change by automatic driving, due to disturbance, such as the handle operation by the driver (override), the avoidance of the obstacle, or the error of vehicle control, even if the own vehicle deviates from the initial target trajectory for the lane change, the target trajectory for the lane change which passes through the position within the prescribed distance range from the current position of the own vehicle corresponding to the state of deviating is generated. Accordingly, since the vehicle control is performed based on the target trajectory for the lane change in which the state of deviating was reflected, the deterioration of riding comfort can be suppressed.

### BRIEF DESCRIPTION OF THE DRAWINGS

FIG. 1 is a schematic configuration diagram of the vehicle system and the control calculation apparatus according to Embodiment 1;

FIG. 2 is a schematic block diagram of the vehicle system and the control calculation apparatus according to Embodiment 1;

FIG. 3 is a schematic hardware configuration diagram of the control calculation apparatus according to Embodiment 1;

FIG. 4 is another example of schematic hardware configuration diagram of the control calculation apparatus according to Embodiment 1;

FIG. 5 is a figure for explaining the problem due to disturbance, such as override, according to Embodiment 1;

FIG. 6 is a figure for explaining generation of the target trajectory for the lane change according to Embodiment 1;

FIG. 7 is a figure for explaining the tangential direction and the lateral direction of lane according to Embodiment 1;

FIG. 8 is a figure for explaining calculation of the current distance of the own vehicle in the lateral direction according to Embodiment 1;

FIG. 9 is a figure for explaining the pattern of the target trajectory according to Embodiment 1;

FIG. 10 is a figure for explaining correction by the correction distance of the target trajectory in the lateral direction according to Embodiment 1;

FIG. 11 is a flowchart for explaining processing of the target trajectory generation unit according to Embodiment 1;

FIG. 12 is a figure for explaining generation of the target trajectory at the start of the lane change on the straight road according to Embodiment 1;

FIG. 13 is a figure for explaining generation of the target trajectory during the lane change on the straight road according to Embodiment 1;

FIG. 14 is a figure for explaining generation of the target trajectory at the start of the lane change on the curve road according to Embodiment 1;

FIG. 15 is a time chart for explaining the control behavior of the lane change on the straight road according to Embodiment 1;

FIG. 16 is a time chart for explaining the control behavior of the lane change on the curve road according to Embodiment 1;

FIG. 17 is a figure for explaining generation of the target trajectory according to Embodiment 1;

FIG. 18 is a flowchart for explaining processing of the control calculation apparatus according to Embodiment 1;

FIG. 19 is a figure for explaining the pattern of the target trajectory according to Embodiment 3;

FIG. 20 is a time chart for explaining the control behavior when accelerating during the lane change according to Embodiment 1; and

FIG. 21 is a time chart for explaining the control behavior when accelerating during the lane change according to Embodiment 3.

### DETAILED DESCRIPTION OF THE EMBODIMENTS

### 1. Embodiment 1

A vehicle system 1 and a control calculation apparatus 50 according to Embodiment 1 will be explained with reference to drawings. In the present embodiment, the vehicle system 1 and the control calculation apparatus 50 are mounted on an own vehicle.

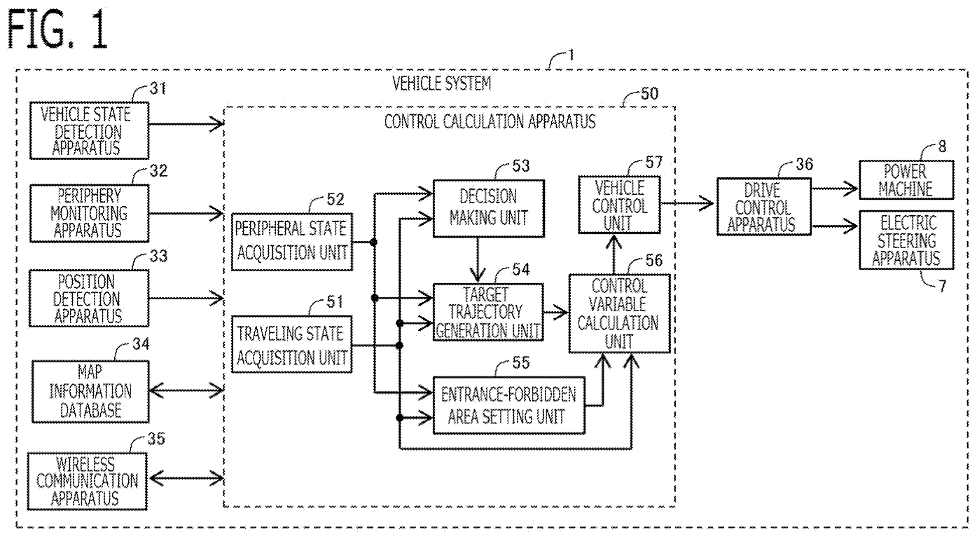

As shown in FIG. 1, the vehicle system 1 is provided with a vehicle state detection apparatus 31, a periphery monitoring apparatus 32, a position detection apparatus 33, a map information database 34, a wireless communication apparatus 35, a control calculation apparatus 50, a drive control apparatus 36, a power machine 8, an electric steering apparatus 7, and the like.

The vehicle state detection apparatus 31 is a detection apparatus which detects a traveling state of the own vehicle. As the traveling state of the own vehicle, a vehicle speed V, an acceleration α, a roll angle speed, a pitch angle speed, and a yaw angle speed y of the own vehicle are detected. For example, as the vehicle state detection apparatus 31, a three axes angular velocity sensor which detects the roll angle speed, the pitch angle speed, and the yaw angle speed which are worked on the own vehicle, an acceleration sensor, and a speed sensor which detects a rotational speed of the wheels are provided. The speed of the own vehicle may be detected by other methods, such as integrating with acceleration.

The periphery monitoring apparatus 32 is apparatus which monitors the periphery of the vehicle, such as a camera and a radar. As the radar, a millimeter wave radar, a laser radar, an ultrasonic radar, and the like are used. The wireless communication device 35 performs a wireless communication with a base station, using the wireless communication standard of cellular communication system, such as 4G and 5G.

The position detecting apparatus 33 is an apparatus which detects the current position (latitude, longitude, altitude) of the own vehicle, and a GPS antenna which receives the signal outputted from satellites, such as GNSS (Global Navigation Satellite System), is used. For detection of the current position of the own vehicle, various kinds of methods, such as the method using the traveling lane identification number of the own vehicle, the map matching method, the dead reckoning method, and the method using the detection information around the own vehicle, may be used.

In the map information database 34, road information, such as a road shape (for example, a road position, a lane number, a shape of each lane, a road type, a regulation speed, and the like), a road sign, and a road signal, is stored. The map information database 34 is mainly constituted of a storage apparatus. The map information database 34 may be provided in a server outside the vehicle connected to the network, and the control calculation apparatus 50 may acquire required road information from the server outside the vehicle via the wireless communication apparatus 35.

As the drive control apparatus 36, a power controller, a brake controller, an automatic steering controller, a light controller, and the like are provided. The power controller controls output of the power machine 8, such as an internal combustion engine and a motor. The brake controller controls brake operation of an electric brake apparatus. The automatic steering controller controls an electric steering apparatus 7. The light controller controls a direction indicator, a hazard lamp, and the like.

### 1-1. Control Calculation Apparatus 50

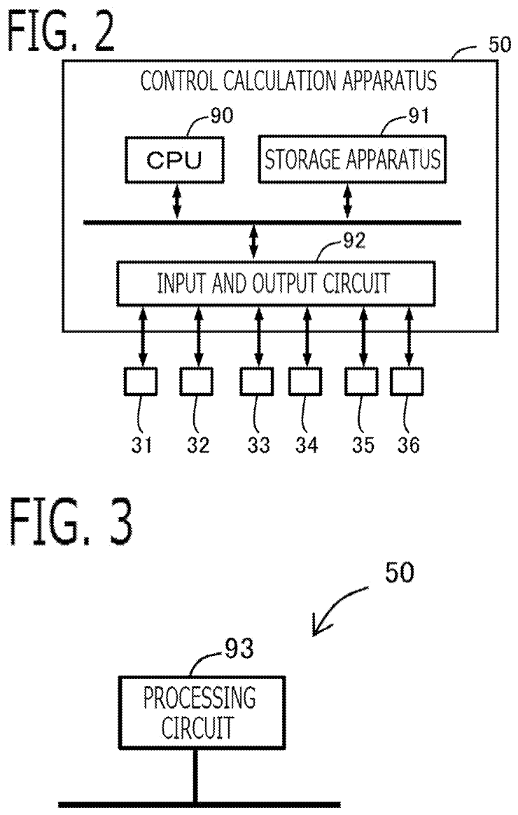

The control calculation apparatus 50 is provided with functional units of a traveling state acquisition unit 51, a peripheral state acquisition unit 52, a decision making unit 53, a target trajectory generation unit 54, an entrance-forbidden area setting unit 55, a control variable calculation unit 56, a vehicle control unit 57, and the like. Each function of the control calculation apparatus 50 is realized by processing circuits provided in the control calculation apparatus 50. As shown in FIG. 2, specifically, the control calculation apparatus 50 is provided with an arithmetic processor 90 such as CPU (Central Processing Unit), storage apparatuses 91, an input and output circuit 92 which outputs and inputs external signals to the arithmetic 90, and the like.

As the arithmetic processor 90, ASIC (Application Specific Integrated Circuit), IC (Integrated Circuit), DSP (Digital Signal Processor), FPGA (Field Programmable Gate Array), GPU (Graphics Processing Unit), AI (Artificial Intelligence) chip, various kinds of logical circuits, various kinds of signal processing circuits, and the like may be provided. As the arithmetic processor 90, a plurality of the same type ones or the different type ones may be provided, and each processing may be shared and executed. As the storage apparatuses 91, various kinds of storage apparatus, such as RAM (Random Access Memory), ROM (Read Only Memory), a flash memory, EEPROM (Electrically Erasable Programmable Read Only Memory), a hard disk, and a DVD apparatus, are used.

The input and output circuit 92 is provided with a communication device, an A/D converter, an input/output port, a driving circuit, and the like. The input and output circuit 92 is connected to the vehicle state detection apparatus 31, the periphery monitoring apparatus 32, the position detection apparatus 33, the map information database 34, the wireless communication apparatus 35, and the drive control apparatus 36, and communicates with these devices.

Then, the arithmetic processor 90 runs software items (programs) stored in the storage apparatus 91 and collaborates with other hardware devices in the control calculation apparatus 50, such as the storage apparatus 91, and the input and output circuit 92, so that the respective functions of the functional units 51 to 57 provided in the control calculation apparatus 50 are realized. Setting data items, such as the pattern of the target trajectory, to be utilized in the functional units 51 to 57 are stored, as part of software items (programs), in the storage apparatus 91 such as an EEPROM.

Alternatively, as shown in FIG. 3, the control calculation apparatus 50 may be provided with a dedicated hardware 93 as the processing circuit, for example, a single circuit, a combined circuit, a programmed processor, a parallel programmed processor, ASIC, FPGA, GPU, AI chip, or a circuit which combined these. Each function of the control calculation apparatus 50 will be described in detail below.

### 1-1-1. Peripheral State Acquisition Unit 52

The peripheral state acquisition unit 52 acquires the peripheral state of the own vehicle. For example, the peripheral state acquisition unit detects the other vehicle and the like which exist around the own vehicle. The peripheral state acquisition unit detects a position, a traveling direction, a traveling speed, and the like of the own vehicle, based on the detection information acquired from the periphery monitoring apparatus 32, and the position information on the own vehicle acquired from the periphery monitoring apparatus 32. The peripheral state acquisition unit 52 detects a travelable road range, an obstacle, a pedestrian, a road sign, and the like other than the other vehicle.

The peripheral state acquisition unit 52 acquires the road information around the own vehicle. The peripheral state acquisition unit 52 acquires the road information around the own vehicle from the map information database 34, based on the position information on the own vehicle acquired from the position detection apparatus 33. In the map information database 34, the road shape (for example, a road position, a lane number, a shape of each lane, a road type, a regulation speed, and the like) and the like are stored.

The peripheral state acquisition unit 52 acquires the road information around the own vehicle detected by the periphery monitoring apparatus 32. For example, the peripheral state acquisition unit 52 detects a shape of lane marking of road and the like, based on the detection information on a lane marking, such as a white line and a road shoulder, which is acquired from the periphery monitoring apparatus 32; and detects a shape of lane, a number of lane, and the like, based on the detected shape of the lane marking of the road and the like. In the present embodiment, the position of the lane marking of road is expressed by a polynomial of plural-order (for example, third-order) in an own vehicle coordinate system.

### 1-1-2. Traveling State Acquisition Unit 51

The traveling state acquisition unit 51 acquires the traveling state of the own vehicle. The traveling state acquisition unit 51 acquires the vehicle speed V, the acceleration α, the yaw angle speed y, the slip angle R, and the like of the own vehicle from the vehicle state detection apparatus 31, as the traveling state of the own vehicle. Well-known technology, such as a low pass filter, an observer, a Kalman filter, and a particle filter, may be used for acquisition of the traveling state. The traveling state acquisition unit 51 acquires the position of the own vehicle, the traveling direction, and the like, based on the position information on the own vehicle acquired from the position detection apparatus 33. The traveling state acquisition unit 51 acquires the information on the traveling position of the own vehicle with respect to each lane, based on the shape of lane acquired from the peripheral state acquisition unit 52. The traveling state acquisition unit 51 acquires a driving operation state, such as the steering angle δ, an output of the power machine, such as the internal combustion engine, and an operating state of the brake, from the vehicle control unit 57

### 1-1-3. Entrance-forbidden Area Setting Unit 55

The entrance-forbidden area setting unit 55 sets an entrance-forbidden area where entrance of the own vehicle is forbidden, based on the peripheral state. The entrance-forbidden area is set to other vehicle, the obstacle, the pedestrian, an area other than the travelable road range, and the like. In the present embodiment, the entrance-forbidden area is set in the own vehicle coordinate system X and Y.

### 1-1-4. Control Variable Calculation Unit 56

The control variable calculation unit 56 calculates a target value of vehicle control variable of the own vehicle, which includes at least a steering angle δ, for the own vehicle to travel along the target trajectory, based on the traveling state of the own vehicle acquired by the traveling state acquisition unit 51, and the target trajectory generated by the target trajectory generation unit 54 described below.

At every calculation period, using a state equation which receives an input variable u related to the vehicle control as input and calculates a state variable x expressing the behavior of the own vehicle, the control variable calculation unit 56 updates the input variable u by repeated calculation from an initial value u0 so as to solve a optimization problem which has an evaluation function that evaluation becomes high as a difference between the target trajectory and the traveling state of the own vehicle becomes small; and calculates an optimum value of input variable u* (k) at each time point k in the prediction period. Then, the control variable calculation unit 56 sets the target value of the vehicle control variable at each time point k, based on the optimum value of state variable x* (k) and the optimum value of input variable u* (k) at each time point k after the optimization problem was solved. Various kinds of well-known methods are used for the calculation for solving this optimization problem. But, explanation is omitted in the present disclosure. For example, ACADO (Automatic Control and Dynamic Optimization) developed by the university K. U. Leuven, AutoGen which is an automatic code creation tool for solving an optimization problem, based on C/GMRES method, or the like is used.

### <State Equation of State Variable>

As shown in the next equation, the state equation of the state variable x is expressed by a function f which receives the state variable x (k) and the input variable u (k) at each time point k, and calculates a time differential dx/dt (k) of the state variable at each time point k. If the state variable is plural, x becomes a vector. If the input variable is plural, u becomes a vector. Herein, k expresses each time point in the prediction period. k=0 is current, and k=N is the end point in the prediction period and is called a horizon.

[Equation 1]

\dot{x}(k)=f(k(k)f(x(k),u(k))

k=0,1, . . . ,N−1,N (1)

For example, as shown in the next equation, the state variable x (k+1) at the next time point is calculated by adding a value obtained by multiplying a time interval ΔTk between the time points in the prediction period to the time differential dx(k)/dt of the state variable at the current time point, to the state variable x (k) at the current time point. Various kinds of calculation methods, such as not only Euler's method like the equation (2) but also Runge Kutta method, may be used.

[Equation 2]

x(k+1)=x(k)+k(k)+\dot{x}(k)ΔTₖ (2)

The state variable x (0) at k=0 is set to the detected current state variable. The input variable u (k) at each time point k in the prediction period (k=0, . . . , N) becomes the initial value or the updated value of the last time repeated calculation for solving the optimization problem. While the time point k is increased one by one from 0 to N, the state variable x (k+1) at the next time point k+1 is calculated in order, using the equation (1) and the equation (2), based on the input variable u (k) and the state variable x (k) at this time point k.

### <Optimization Problem>

A general optimization problem like the next equation is considered. Herein, J is an evaluation function which evaluates the state variable x (k) and the input variable u (k). g is a constraint condition which constrains the state variable x (k) and the input variable u (k), and there are the constraint conditions of a set number Z. That is to say, while satisfying the constraint condition, the input variable u which minimizes the evaluation function J is calculated. The positive/negative of the evaluation function may be inverted, and it may be a maximum problem which maximizes the evaluation function.

[Equation 3]

Minimize j(x(k),u(k)) (3)

subject to gᵢ (x(k), u(k))≤0
k=0, . . . , N
i==1, . . . , Z

### <Constraint Condition of Entrance-Forbidden Area>

In the present embodiment, as the constraint condition g, a constraint condition that the vehicle does not enter into an entrance-forbidden area is set. This constraint condition g is a function which becomes larger than 0, when the position Xvh (k), Yvh (k) of the own vehicle at each time point k is within the entrance-forbidden area. The state variable x (k) and the input variable u (k) are constrained so that this constraint condition g becomes less than or equal to 0.

As the constraint condition g, a condition which upper-limits and lower-limits a target value of jerk jo and a target value of steering angle speed ωo is set. As the constraint condition g, other conditions may be used.

### <Vehicle Model>

In the present embodiment, as the state equation, a state equation of a vehicle model which receives the input variable u related to vehicle control, and calculate the state variable x expressing the behavior of the own vehicle is used. A two-wheel model is used for the vehicle model. As shown in the next equation, the state equation of the vehicle model can be expressed by a differential equation of each state variable expressing the behavior of the own vehicle. As the state equation of the vehicle model, various kinds of well-known state equations may be used.

$$[ Equation 4 ]$$

$$\dot{x} ( k ) = [ \begin{matrix}{\dot{X}}_{vh} ( k ) \\ {\dot{Y}}_{vh} ( k ) \\ \dot{θ} ( k ) \\ \dot{β} ( k ) \\ \dot{γ} ( k ) \\ \dot{V} ( k ) \\ \dot{α} ( k ) \\ {\dot{α}}_{o} ( k ) \\ \dot{δ} ( k ) \\ {\dot{δ}}_{o} ( k )\end{matrix} ] = [ \begin{matrix}V ( k ) cos ( θ ( k ) + β ( k ) ) \\ V ( k ) sin ( θ ( k ) + β ( k ) ) \\ γ ( k ) \\ - γ ( k ) + \frac{2 ( {F}_{f} ( k ) + {F}_{r} ( k ) )}{M \cdot V ( k )} \\ \frac{2}{I} ( {L}_{f} {F}_{f} ( k ) - {L}_{r} {F}_{r} ( k ) ) \\ α ( k ) \\ \frac{{α}_{o} ( k ) - α ( k )}{{T}_{α}} \\ {j}_{o} ( k ) \\ \frac{{δ}_{o} ( k ) - δ ( k )}{{T}_{δ}} \\ {ω}_{o} ( k )\end{matrix} ] \\ {F}_{f} ( k ) = - {C}_{f} ( β ( k ) + \frac{{L}_{f}}{V ( k )} γ ( k ) - δ ( k ) ) \\ {F}_{r} ( k ) = - {C}_{r} ( β ( k ) - \frac{{L}_{r}}{V ( k )} γ ( k ) ) \\ u ( k ) = {[ {j}_{o} ( k ) , {ω}_{o} ( k ) ]}^{T} \qquad ( 4 )$$

Herein, a dot sign of the upper part of each variable of the left side indicates a time differential value of each state variable. As the state variable x, Xvh indicates a position of the own vehicle in a longitudinal direction X in the own vehicle coordinate system, Yvh indicates a position of the own vehicle in a lateral direction Y in the own vehicle coordinate system, θ is an inclination of the own vehicle with respect to the longitudinal direction X of the own vehicle coordinate system, β is a lateral slip angle of a center of gravity of the own vehicle, y is a yaw angle speed of the own vehicle, V is a speed of the own vehicle, α is an acceleration of the own vehicle, αo is a target value of acceleration, δ is a steering angle of wheel of the own vehicle, and δo is a target value of steering angle.

I is a yaw inertia moment of vehicle, M is a mass of vehicle, Lf is a distance between the vehicle center of gravity and an axle of the front wheel, and Lr is a distance between the vehicle center of gravity and an axle of the rear wheel. Ff is a cornering force of the front wheel, Fr is a cornering force of the rear wheel, Cf is a cornering stiffness of the front wheel tire, Cr is a cornering stiffness of the rear wheel tire. Tα is a time constant if a following delay of the acceleration α with respect to the target value of acceleration αo is expressed by a first order lag, and Tδ is a time constant if a following delay of the steering angle δ with respect to the target value of steering angle δo is expressed by a first order lag.

The input variable u is the target value of jerk jo of the own vehicle, and the target value of steering angle speed ωo.

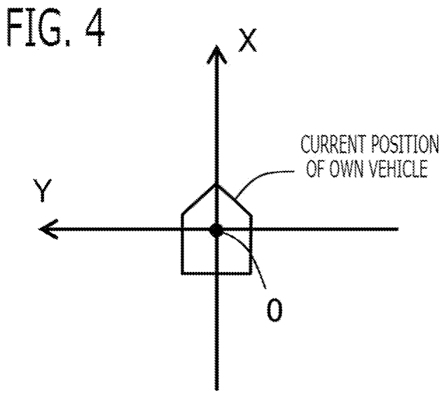

The state equation is expressed in the own vehicle coordinate system X and Y. As shown in FIG. 4, the own vehicle coordinate system X and Y are a coordinate system on the basis of the current position of the own vehicle, and is a coordinate system in which the two coordinate axes X and Y are set to the longitudinal direction X of the current own vehicle, and the lateral direction Y of the current own vehicle. An origin of the own vehicle coordinate system is set to a representative position of the current own vehicle. The representative position of an own vehicle is set to a gravity center or a neutral steer point. As long as the representative position of the own vehicle is a position within a range where the current own vehicle is projected on the road, it may be any position. Instead of the own vehicle coordinate system, a coordinate system on the basis of the target trajectory may be used.

### <Evaluation Function>

In the present embodiment, the next equation is used as the evaluation function J. As a difference between the target traveling state (target trajectory) and the prediction traveling state becomes small, the value of the evaluation function J becomes small. As the evaluation function J, one that is deformed from the next equation may be used.

$$[ Equation 5 ]$$

$$J = {( y ( N ) - {y}_{o} ( N ) )}^{T} P ( y ( N ) - {y}_{o} ( N ) ) + {\sum }_{k = 1}^{N - 1} ( {( y ( k ) - {y}_{o} ( k ) )}^{T} Q ( y ( k ) - {y}_{o} ( k ) ) + {u ( k )}^{T} Ru ( k ) ) \qquad ( 5 )$$

$$y ( k ) = {[ {X}_{vh} ( k ) , {Y}_{vh} ( k ) , θ ( k ) , V ( k ) ]}^{T} \\ {y}_{o} ( k ) = {[ {X}_{o} ( k ) , {Y}_{o} ( k ) , {θ}_{o} ( k ) , {V}_{o} ( k ) ]}^{T}$$

Herein, k (k=0, 1, . . . , N−1, N) is a time point number expressing each time point in the prediction period. k=0 is current and k=N expresses the final prediction time point. The time point number k is increased one by one from 0 to N at every time interval ΔTk. Accordingly, k×ΔTk is an elapsed time of each time point k from current. y (k) is a vector of the output variables of the state equation at each time point k. yo (k) is a vector of the target values of output variables at each time point k, and values of the target trajectory at each time point k described below are set. P is a weight to a deviation from the target value of output variable at the final prediction time point (k=N). Q is a weight to a deviation from the target value of output variable at the future each time point (k=1, . . . , N−1) except the final prediction time point. A deviation of the traveling state of the vehicle from the target trajectory at each time point is evaluated by terms of these weights P and Q. R is a weight to the input variable u at the future each time point (k=1, . . . , N−1) except the final prediction time point. The target value of jerk jo of the own vehicle and the target value of steering angle speed ωo are evaluated so as not to become large too much, by a term of this weight R. Accordingly, variation of the steering angle and variation of the vehicle acceleration, and a following performance to the target trajectory is balanced by setting of each weight P, Q, and R. Vehicle control with few uncomfortable feelings for the driver is performed. There may be no term of the weight R which evaluates the input variable u.

The target value of the vehicle control variable at each time point k is set based on the optimum value of the state variable x* (k) and the input variable u* (k) at each time point k after the optimization problem was solved. In the present embodiment, the target value of the vehicle control variable at each time point k is set to the target value of steering angle δo* (k) and the target value of acceleration αo* (k) included in optimum value x* (k) of the state variable at each time point k.

### 1-1-5. Vehicle Control Unit 57

The vehicle control unit 57 calculates a control variable, based on the target value of vehicle control variable calculated by the control variable calculation unit 56, and controls the own vehicle using the control variable. Herein, the control variable is an electrical current value or the like which is calculated so that the own vehicle follows the target value. In the present embodiment, the target value of vehicle control variable is the target value of steering angle αo (k) at each time point k and the target value of acceleration αo (k) at each time point.

The vehicle control unit 57 calculates a control variable to the power controller, a control variable to the brake controller, and a control variable to the automatic steering controller, based on the target value of steering angle αo (k) at each time point k, and the target value of acceleration αo (k) at each time point k; and transmits to each apparatus. The vehicle control unit 57 may not be provided in the control calculation apparatus 50, and may be provided in the vehicle system 1.

The power controller controls the output of the power machine, such as the internal combustion engine and the motor, according to the control variable. The brake controller controls the brake operation of the electric brake apparatus according to the control variable. The automatic steering controller controls the electric steering apparatus according to the control variable.

### 1-1-6. Decision Making Unit 53

The decision making unit 53 determines a target behavior of the own vehicle. The decision making unit 53 determines a target behavior which the own vehicle should take, and a target lane where the own vehicle should travel, based on the traveling state of the own vehicle, the peripheral state, the road information, and the like. In options of target behavior, at least a lane keeping and a lane change are included. A stop, an urgency stop, or the like may be included other than these. Well-known technology, such as a finite state machine, ontology, a decision tree, reinforcement learning, or a Markov decision process, is used for the decision making. In the present embodiment, the finite state machine is used.

For example, at the start of automatic driving, the decision making unit 53 sets the target behavior to the lane keeping. When the driver manipulates the winker in other than intersection, the decision making unit 53 sets the target behavior to the lane change. The decision making unit 53 determines necessity of the lane change, based on the destination and the current traveling lane of the own vehicle; and sets the target behavior to the lane change. The decision making unit 53 determines necessity of overtaking of the front vehicle; and sets the target behavior to the lane change, if the overtaking is necessary. The decision making unit 53 also sets whether the lane change is to the right lane or to the left lane.

For example, when the target behavior is the lane keeping, the decision making unit 53 sets the target lane to the lane where the own vehicle is traveling (referred to as an own lane). When the target behavior is the lane change to the right, the decision making unit 53 sets the target lane to the right side lane of the own lane (referred to as a right lane). When the position of the own vehicle moves to the range of the right lane during the lane change to the right lane, the own lane becomes the original right lane and the target lane becomes the current own lane (the original right lane). The lane change to the left is also similar.

### 1-1-7. Target Trajectory Generation Unit 54

The target trajectory generation unit 54 generates the target trajectory. In the present disclosure, mainly, generation of the target trajectory for the lane change will be explained. After the target behavior was changed into the lane change from the lane keeping or the like by the decision making unit 53, the target trajectory generation unit 54 starts generation of the target trajectory for the lane change.

### <Problem of Generation of Target Trajectory for the Lane Change>

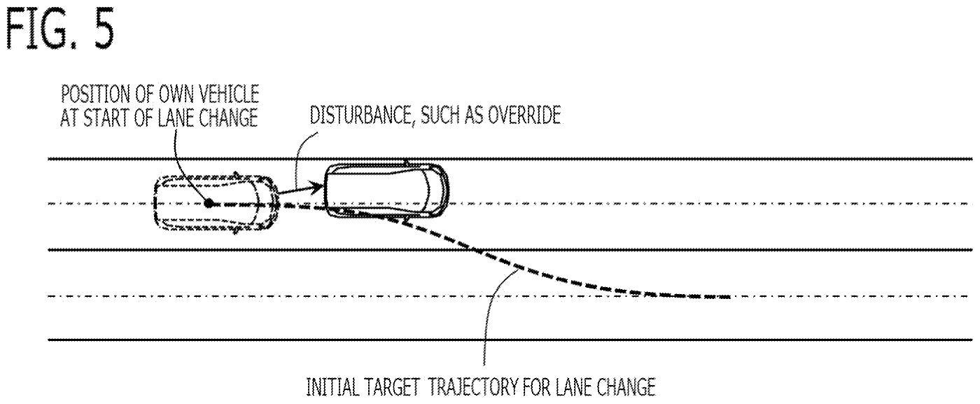

As shown in FIG. 5, after the start of the lane change by automatic driving, when a handle operation (override) by the driver is performed, or when the target value of steering angle δo for avoiding the entrance-forbidden area, such as the obstacle, is set, or when the error of vehicle control occurs, the own vehicle may deviate from the initial target trajectory for the lane change. If the initial target trajectory is not changed, and the own vehicle continues automatic driving of the lane change in a state of deviating from the initial target trajectory, the vehicle control variable becomes excessive, and the traveling trajectory changes. Ideal lane change cannot be performed, and the riding comfort may be deteriorated.

Then, in the present embodiment, after the generation start of the target trajectory for the lane change, the target trajectory generation unit 54 generates the target trajectory for the lane change which passes through a position within a prescribed distance range from the current position of the own vehicle detected based on the traveling state.

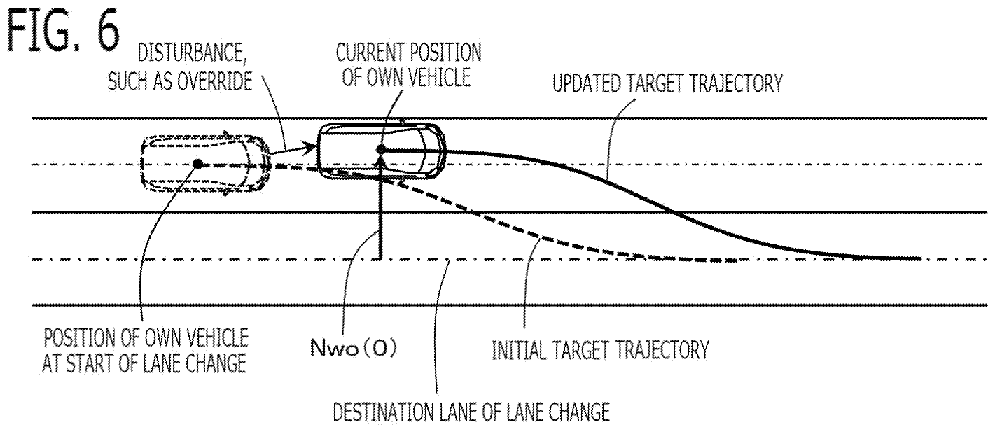

According to this configuration, as shown in FIG. 6, after the start of the lane change by automatic driving, due to disturbance, such as the handle operation by the driver (override), the avoidance of the obstacle, or the error of vehicle control, even if the own vehicle deviates from the initial target trajectory for the lane change, the target trajectory for the lane change which passes through the position within the prescribed distance range from the current position of the own vehicle corresponding to the state of deviating is generated. Accordingly, since the vehicle control is performed based on the target trajectory for the lane change in which the state of deviating was reflected, the deterioration of riding comfort can be suppressed.

In the present embodiment, the position within the prescribed distance range from the current position of the own vehicle is set to a position within a range where the current own vehicle is projected on the road. For example, the position within the prescribed distance range is set to the representative position of the own vehicle, such as the gravity center or the neutral steer point. As long as the position within the prescribed distance range is a position within the range where the current own vehicle is projected on the road, it may shift from the representative position of the own vehicle.

### <Trajectory Generation by Shift of Pattern of Target Trajectory in Time Direction>

And, in the present embodiment, the target trajectory generation unit 54 uses a pattern of the target trajectory for the lane change which was set in a coordinate system consisting of an axis of time and an axis of a distance of the target trajectory in the lateral direction ΔWo with respect to a destination lane of the lane change; and shifts the pattern of the target trajectory in the time direction so that the pattern of the target trajectory passes through the position (in this example, the current representative position of the own vehicle) within the prescribed distance range from the current position of the own vehicle, and generates the target trajectory for the lane change.

According to this configuration, as shown in FIG. 6, due to disturbance, such as the handle operation (override) by the driver, even if the own vehicle deviates from the initial target trajectory for the lane change, the pattern of the target trajectory is shifted in the time direction so that the pattern of the target trajectory passes through the position (in this example, the current position of the own vehicle) within the prescribed distance range from the current position of the own vehicle corresponding to the state of deviating, and the target trajectory is generated. Accordingly, since the pattern of the target trajectory which passes through the position within the prescribed distance range from the current position of the own vehicle is used, the riding comfort which was supposed with the pattern of the target trajectory can be suppressed from deteriorating.

### <Time Shift Based on Current Distance of Own Vehicle in Lateral Direction ΔWvh (0)>

In the present embodiment, the target trajectory generation unit 54 calculates a current distance of the own vehicle in the lateral direction ΔWvh (0) with respect to the destination lane of the lane change, based on the traveling state; by referring to the pattern of the target trajectory, calculates current time in the pattern of the target trajectory corresponding to the current distance of the own vehicle in the lateral direction ΔWvh (0); by referring to the pattern of the target trajectory, calculates the distance of the target trajectory in the lateral direction ΔWo (k) at each time point k of current and future corresponding to time at each time point k of current and future after the calculated current time; and generates the target trajectory for the lane change, using the calculated distance of the target trajectory in the lateral direction ΔWo (k) at each time point k of current and future.

According to this configuration, the corresponding time at each time point k of current and future in the pattern of the target trajectory is calculated based on the current distance of the own vehicle in the lateral direction ΔWvh (0), and the corresponding distance of the target trajectory in the lateral direction ΔWo (k) at each time point k of current and future in the pattern of the target trajectory can be calculated. Accordingly, by the current distance of the own vehicle in the lateral direction ΔWvh (0), the pattern of the target trajectory is rationally and accurately shifted in the time direction so as to pass through the current position of the own vehicle, and the target trajectory can be generated.

The target trajectory generation unit 54 corrects the position of the destination lane of the lane change which is the target lane, by the distance of the target trajectory in the lateral direction ΔWo (k) at each time point k of current and future, and generates the target trajectory for the lane change. In the present embodiment, the target trajectory is set in the own vehicle coordinate system X and Y.

In the following, processing of the target trajectory generation unit 54 according to the present embodiment will be explained in detail.

### <Setting of Position of Destination Lane of Lane Change>

The center position of the destination lane of the lane change is set as the position XoC, YoC of the destination lane of the lane change. The position X, Y of the lane marking of the lane in the own vehicle coordinate system can be expressed by using a polynomial of plural-order (for example, third-order) in which the position X in the longitudinal direction is set as an independent variable, and the position Y in the lateral direction is set as a dependent variable. The position of each lane marking is acquired by the peripheral state acquisition unit 52. A function other than the third-order polynomial may be used.

As shown in the next equation, the position XoR, YoR of the division line on the right side of the destination lane of the lane change is expressed by a third-order polynomial, as shown in the equation (6); and the position XoL, YoL of the division line on the left side of the destination lane of the lane change is expressed by a third-order polynomial, as shown in the equation (7). As shown in the equation (8), the center position XoC, YoC of the destination lane of the lane change is set to the center between the position of the division line on the right side of the equation (6) and the position of the division line on the left side of the equation (7). This center position is set as the position of the destination lane of the lane change.

$$[ Equation 6 ]$$

$${Y}_{oR} = K {0}_{oR} + K {1}_{oR} {X}_{oR} + K {2}_{oR} {X}_{oR}^{2} + K {3}_{oR} {X}_{oR}^{3} \qquad ( 6 )$$

$$[ Equation 7 ]$$

$${Y}_{oL} = K {0}_{oL} + K {1}_{oL} {X}_{oL} + K {2}_{oL} {X}_{oL}^{2} + K {3}_{oL} {X}_{oL}^{3} \qquad ( 7 )$$

$$[ Equation 8 ]$$

$${Y}_{oC} = K {0}_{oC} + K {1}_{oC} {X}_{oC} + K {2}_{oC} {X}_{oC}^{2} + K {3}_{oC} {X}_{oC}^{3} \\ K {0}_{oC} = \frac{1}{2} ( K {0}_{oL} + K {0}_{oR} ) , K {1}_{oC} = \frac{1}{2} ( K {1}_{oL} + K {1}_{oR} ) , \\ K {2}_{oC} = \frac{1}{2} ( K {2}_{oL} + K {2}_{oR} ) \qquad ( 8 )$$

The target trajectory generation unit 54 sets time series data of the destination lane of the lane change at each time point k of current and future (k=0, . . . , N). The time series data includes a position XoC (k) in the longitudinal direction, a position YoC (k) in the lateral direction, a target value of vehicle speed Vo (k), and an inclination angle φ (k) of a tangential direction S of the lane with respect to the longitudinal direction X, at each time point k. The target trajectory generation unit 54 sets the target value of vehicle speed Vo (k) at each time point k, based on the current vehicle speed V, the vehicle speed of the front vehicle, the regulation speed of the traveling lane, and the like. For example, the target value of vehicle speed Vo (k) at each time point k is set to the current vehicle speed V.

Then, while increasing the time point k one by one in order from the current time point k=0, the target trajectory generation unit 54 calculates the position XoC (k+1) in the longitudinal direction and the position YoC (k+1) in the lateral direction at the next time point k+1 that the equation (8) and the equation (9) are established at the same time, at each time point k. Herein, ΔTk is a time interval between the time points.

$$[ Equation 9 ]$$

$$\sqrt{{( {X}_{oC} ( k + 1 ) - {X}_{oC} ( k ) )}^{2} + {( {Y}_{oC} ( k + 1 ) - {Y}_{oC} ( k ) )}^{2}} = {V}_{o} ( k ) Δ {T}_{k} \qquad ( 9 )$$

The target trajectory generation unit 54 calculates the tangential direction S of the destination lane of the lane change at each time point k, based on the position XoC in the longitudinal direction and the position YoC in the lateral direction of the destination lane of the lane change at each time point k and before and after of each time point k−1, k+1; and calculates the inclination angle φ (k) of the tangential direction S with respect to the longitudinal direction X of the own vehicle coordinate system. An angle orthogonal to this inclination angle φ (k) of the tangential direction S becomes an inclination angle of the road width direction W (lateral direction W) of the destination lane of the lane change with respect to the longitudinal direction X of the own vehicle coordinate system. The inclination angle φ of the tangential direction S becomes a positive value when the tangential direction S inclines to the right side with respect to the longitudinal direction X, and it becomes a negative value when the tangential direction S inclines to the left side with respect to the longitudinal direction X.

### <Setting of Lateral Direction W>

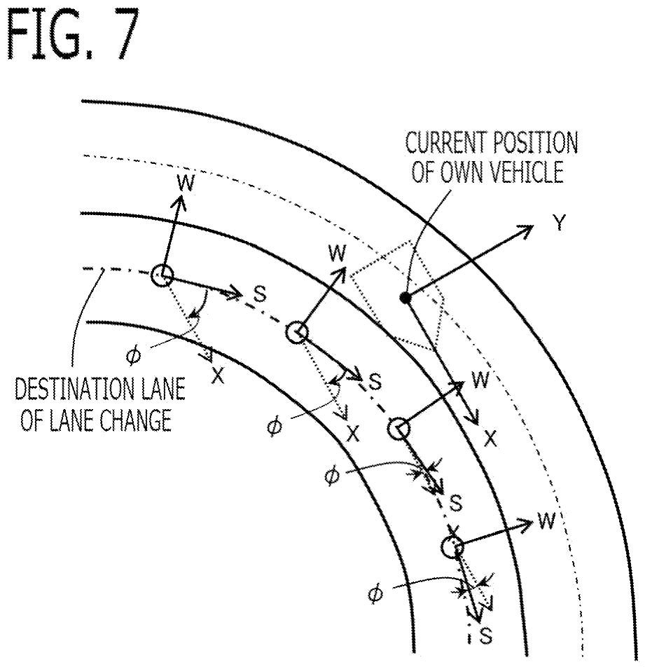

In the present embodiment, the target trajectory generation unit 54 uses the road width direction W at each position of the destination lane of the lane change, as the lateral direction. As shown in FIG. 7, the road width direction W at each position is a direction orthogonal to the tangential direction S of the lane at each position. The target trajectory generation unit 54 calculates the lateral direction W (k) which is a road width direction orthogonal to the tangential direction S (k) of the destination lane of the lane change at each time point k, based on the position XoC in the longitudinal direction and the position YoC in the lateral direction of the destination lane of the lane change at each time point k and before and after of each time point k−1, k+1.

### <Calculation of Current Distance of Own Vehicle in Lateral Direction ΔWvh (0)>

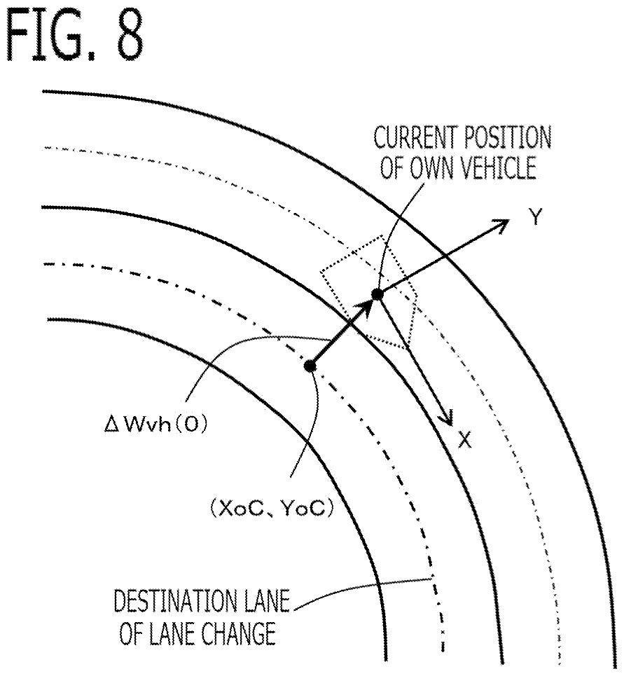

As shown in FIG. 8, the target trajectory generation unit 54 calculates the current distance of the own vehicle in the lateral direction ΔWvh (0) with respect to the destination lane of the lane change, based on the current position of the own vehicle and the position of the destination lane of the lane change. In the present embodiment, the target trajectory generation unit 54 calculates the current distance of the own vehicle in the lateral direction ΔWvh (0) with respect to the destination lane of the lane change, in the lateral direction W (the road width direction) of the destination lane of the lane change, based on the position XoC, YoC of the destination lane of the lane change expressed in the own vehicle coordinate system X and Y on the basis of the current position of the own vehicle.

The target trajectory generation unit 54 determines a position XoC, YoC of the destination lane of the lane change whose lateral direction W passes through the current position of the own vehicle; and calculates the current distance of the own vehicle in the lateral direction ΔWvh (0), based on the determined position XoC, YoC, using the next equation. ΔWvh (0) becomes a positive value when the own vehicle is located on the left side with respect to the destination lane of the lane change; and ΔWvh (0) becomes a negative value when the own vehicle is located on the right side.

[Equation 10]

ΔWvh(0)=±\sqrt{X_{oC}²+Y_{oC}²} (10)

According to this configuration, even if the longitudinal direction X of the own vehicle inclines with respect to the tangential direction S of the destination lane of the lane change during the lane change, since the current distance ΔWvh (0) in the lateral direction (road width direction) of the own vehicle with respect to the destination lane of the lane change is calculated, the current normalization lateral distance Nwvh (0) of the own vehicle described below can be calculated with good accuracy.

### <Setting of Pattern of Target Trajectory by Normalization Time Nt and Normalization Lateral Distance Nwo>

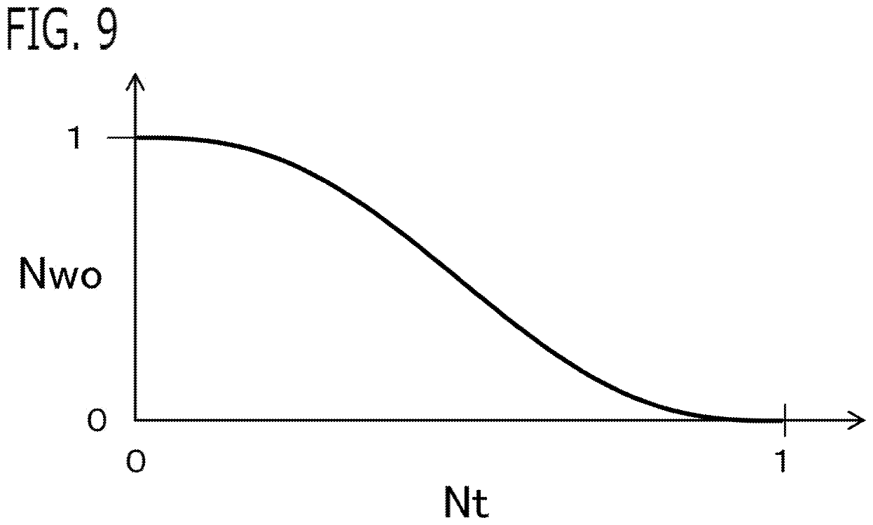

In the present embodiment, an axis of the normalization time Nt is used as the axis of time, and an axis of the normalization lateral distance Nwo of the target trajectory is used as the axis of the distance of the target trajectory in the lateral direction. Then, as shown in FIG. 9, the pattern of the target trajectory is preliminarily set in a coordinate system consisting of the axis of the normalization time Nt and the axis of the normalization lateral distance Nwo of the target trajectory. Herein, the normalization time Nt is one that time is normalized by a required time for the lane change ΔTcl corresponding to a total time of the pattern of the target trajectory. The normalization lateral distance Nwo of the target trajectory is one that the distance of the target trajectory in the lateral direction ΔWo is normalized by a required lateral distance for the lane change ΔWoall corresponding to a total distance of the pattern of the target trajectory in the lateral direction.

Then, by referring to the pattern of the target trajectory, the target trajectory generation unit 54 calculates the current normalization time Nt (0) corresponding to a current normalization lateral distance Nwvh (0) of the own vehicle that the current distance of the own vehicle in the lateral direction ΔWvh (0) is normalized by the required lateral distance for the lane change ΔWoall; by referring to the pattern of the target trajectory, calculates the normalization lateral distance Nwo (k) of the target trajectory at each time point k of current and future corresponding to the normalization time Nt (k) at each time point k of current and future after the calculated current normalization time Nt (0); and generates the target trajectory for the lane change, using the calculated normalization lateral distance Nwo (k) of the target trajectory at each time point k of current and future, and the required lateral distance for the lane change ΔWoall.

According to this configuration, since the pattern of the target trajectory is set by the normalization time Nt and the normalization lateral distance Nwo of the target trajectory, even if the required time for the lane change ΔTcl and the required lateral distance for the lane change ΔWoall are changed, the same pattern of the target trajectory can be used, the calculation processing is simplified, and the processing load can be reduced.

### <Setting of Required Lateral Distance for Lane Change ΔWoall>

The target trajectory generation unit 54 calculates an absolute value of the current distance of the own vehicle in the lateral direction ΔWvh (0) with respect to the destination lane of the lane change at the generation start of the target trajectory for the lane change, as the initial required lateral distance for the lane change ΔWoall. When the absolute value of the current distance of the own vehicle in the lateral direction ΔWvh (0) exceeds the required lateral distance for the lane change ΔWoall which is set currently, after the generation start of the target trajectory for the lane change, the target trajectory generation unit 54 sets the absolute value of the current distance of the own vehicle in the lateral direction ΔWvh (0), as the required lateral distance for the lane change ΔWoall. The required lateral distance for the lane change ΔWoall is set to a positive value.

According to this configuration, after the start of the lane change, when the own vehicle moves in the direction opposite to the destination lane of the lane change due to disturbance, such as the override, and the absolute value of the current distance of the own vehicle in the lateral direction ΔWvh (0) exceeds the initial required lateral distance for the lane change ΔWoall at the start of the lane change, the absolute value of the current distance of the own vehicle in the lateral direction ΔWvh (0) is set to the required lateral distance for the lane change ΔWoall, and is updated. Accordingly, the required lateral distance for the lane change ΔWoall corresponding to this deviation state is set, and the ideal target trajectory for the lane change can be generated.

### <Calculation of Current Normalization Lateral Distance Nwvh (0) of Own Vehicle>

The target trajectory generation unit 54 calculates the current normalization lateral distance Nwvh (0) of the own vehicle that the current distance of the own vehicle in the lateral direction ΔWvh (0) is normalized by the required lateral distance for the lane change ΔWoall.

In the present embodiment, the target trajectory generation unit 54 calculates a current completion degree of the lane change in the lateral direction Rw (0), based on the required lateral distance for the lane change ΔWoall and the current distance of the own vehicle in the lateral direction ΔWvh (0); and calculates the current normalization lateral distance Nwvh (0) of the own vehicle, based on the current completion degree of the lane change in the lateral direction Rw (0).

Specifically, as shown in the next equation, the target trajectory generation unit 54 calculates the current completion degree of the lane change in the lateral direction Rw (0) by subtracting, from 1, a value obtained by dividing the current distance of the own vehicle in the lateral direction ΔWvh (0) by the required lateral distance for the lane change ΔWoall. The current completion degree of the lane change in the lateral direction Rw (0) is lower-limited by 0, and is upper-limited by 1. Herein, in the present embodiment, since the left side in the lateral direction is defined as positive, and the right side in the lateral direction is defined as negative, the absolute value of the distance of the own vehicle in the lateral direction ΔWvh (0) is used.

$$[ Equation 11 ]$$

$$Rw ( 0 ) = 1 - \frac{\vert Δ Wvh ( 0 ) \vert}{Δ Woall} \\ 0 \leq Rw ( 0 ) \leq 1 \qquad ( 11 )$$

Then, as shown in the next equation, the target trajectory generation unit 54 calculates the current normalization lateral distance Nwvh (0) of the own vehicle by subtracting the current completion degree of the lane change in the lateral direction Rw (0) from 1. The current normalization lateral distance Nwvh (0) of the own vehicle is lower-limited by 0, and is upper-limited by 1. As shown in the equation (12), the current normalization lateral distance Nwvh (0) of the own vehicle may be directly calculated based on the current distance of the own vehicle in the lateral direction ΔWvh (0) and the required lateral distance for the lane change ΔWoall.

$$[ Equation 12 ]$$

$$Nwvh ( 0 ) = 1 - Rw ( 0 ) = \frac{\vert Δ Wvh ( 0 ) \vert}{Δ Woall} \\ 0 \leq Nwvh ( 0 ) \leq 1 \qquad ( 12 )$$

### <Pattern of Target Trajectory>

In the present embodiment, as the pattern of the target trajectory, the target trajectory generation unit 54 uses a polynomial in which the normalization time Nt is set as an independent variable, and the normalization lateral distance Nwo of the target trajectory is set as a dependent variable. For example, a polynomial of fifth-order shown in the next equation and FIG. 9 is used. Herein, fpt is a function expressing the pattern of the target trajectory. Besides the polynomial, an arbitrary function, such as map data, may be used as the pattern of the target trajectory. The pattern of the target trajectory has characteristics that Nwo=1 at Nt=0, Nwo=0 at Nt=1, and Nwo decreases monotonically from 1 to 0 as Nt increases from 0 to 1.

[Equation 13]

Nwo=fpt(Nt)=1−(6Nt⁵−15Nt⁴+10Nt³) (13)

In the equation (13), since a differential value dNwo/dNt obtained by differentiating the normalization lateral distance Nwo of the target trajectory with respect to the normalization time Nt becomes 0 at the start time Nt=0 and the completion time Nt=1 of the lane change, the target trajectory for the lane change and the lanes before and after the lane change are connected smoothly, and the riding comfort during the lane change is improved. An arbitrary function besides the equation (13) may be used.

### <Calculation of Current Normalization Time Nt (0)>

As mentioned above, by referring to the pattern of the target trajectory, the target trajectory generation unit 54 calculates the current normalization time Nt (0) corresponding to the current normalization lateral distance Nwvh (0) of the own vehicle.

In the present embodiment, as shown in the next equation, the target trajectory generation unit 54 calculates the current normalization time Nt (0) corresponding to the current normalization lateral distance Nwvh (0) of the own vehicle, using an inverse function fpt⁻¹ of the pattern of the target trajectory of the equation (13). The inverse function fpt⁻¹ is preliminarily set based on the equation (13). The current normalization time Nt (0) is lower-limited by 0, and is upper-limited by 1.

[Equation 14]

Nt(0)=fpt⁻¹(Nwvh(0)) (14)

### <Calculation of Normalization Time Nt (k) at Each Time Point k of Current and Future>

The target trajectory generation unit 54 sets the required time for the lane change ΔTcl. For example, the target trajectory generation unit 54 sets a target travel distance after starting the lane change until the lane change is completed, and calculates the required time for the lane change ΔTcl by dividing the target travel distance by the current vehicle speed.

The target trajectory generation unit 54 sets the normalization time Nt (k) at each time point k of current and future after the current normalization time Nt (0). For example, as shown in the next equation, as the time point k increases from 0, the target trajectory generation unit 54 increases the normalization time Nt (k) by the change variable of normalization time (ΔTk/ΔTcl) from Nt (0), and sets the normalization time Nt (k) at each time point k of current and future. The target trajectory generation unit 54 upper-limits the normalization time Nt (k) by 1 of the maximum value.

$$[ Equation 15 ]$$

$$Nt ( k ) = Nt ( 0 ) + \frac{Δ {T}_{k}}{Δ {T}_{cl}} k \\ Nt ( k ) \leq 1 , k = 0 , … , N \qquad ( 15 )$$

### <Calculation of Normalization Lateral Distance Nwo (k) of Target Trajectory at Each Time Point k of Current and Future>

As mentioned above, by referring to the pattern of the target trajectory, the target trajectory generation unit 54 calculates the normalization lateral distance Nwo (k) of the target trajectory at each time point k of current and future corresponding to the normalization time Nt (k) at each time point k of current and future.

In the present embodiment, about each time point k=0, . . . , N, by using the pattern of the target trajectory of the equation (13) as shown in the next equation, the target trajectory generation unit 54 calculates the normalization lateral distance Nwo (k) of the target trajectory at each time point k corresponding to the normalization time Nt (k) at each time point k. The normalization lateral distance Nwo (k) of the target trajectory at each time point k is lower-limited by 0, and is upper-limited by 1. As mentioned above, as the pattern of the target trajectory, an equation or map data which is different from the equation (13) and the equation (16) may be used. The pattern of the target trajectory has characteristics that Nwo=1 at Nt=0, Nwo=0 at Nt=1, and Nwo decreases monotonically from 1 to 0 as Nt increases from 0 to 1.

[Equation 16]

Nwo(k)=fpt(Nt(k))=1+(6Nt(k)⁵+15Nt(k)⁴+10Nt(k)³)0≤Nwo(k)≤1 (16)

k=0, . . . , N

### <Calculation of Distance of Target Trajectory in Lateral Direction ΔWo (k) at Each Time Point k of Current and Future>

The target trajectory generation unit 54 calculates the distance of the target trajectory in the lateral direction ΔWo (k) at each time point k of current and future, based on the normalization lateral distance Nwo (k) of the target trajectory at each time point k of current and future, and the required lateral distance for the lane change ΔWoall.

In the present embodiment, about each time point k=0, . . . , N, as shown in the next equation, the target trajectory generation unit 54 calculates the distance of the target trajectory in the lateral direction ΔWo (k) by multiplying the required lateral distance for the lane change ΔWoall to the normalization lateral distance Nwo (k) of the target trajectory. In the present embodiment, the left side of the lateral direction W is positive and the right side of the lateral direction W is negative, and the required lateral distance for the lane change ΔWoall is a positive value. Accordingly, in the case of the lane change to the left side lane, since the target trajectory is generated by moving the position of the left side lane of the lane change destination in the right side direction, a value obtained by multiplying −1 to the multiplication value is set as ΔWo (k). In the case of the lane change to the right side lane, since the target trajectory is generated by moving the position of the right side lane of the lane change destination in the left side direction, the multiplication value is set as ΔWo (k) as it is. Setting of the positive/negative of the calculation equation may be changed according to setting of the coordinate system, and the definition of each value.

[Equation 17]
1) In the case of the lane change to the left side,

ΔWo(k)=−ΔWoall×Nwo(k)
2) In the case of the lane change to the right side,

ΔWo(k)=ΔWoall×Nwo(k) (17)
k=0, . . . , N

### <Generation of Target Trajectory for Lane Change>

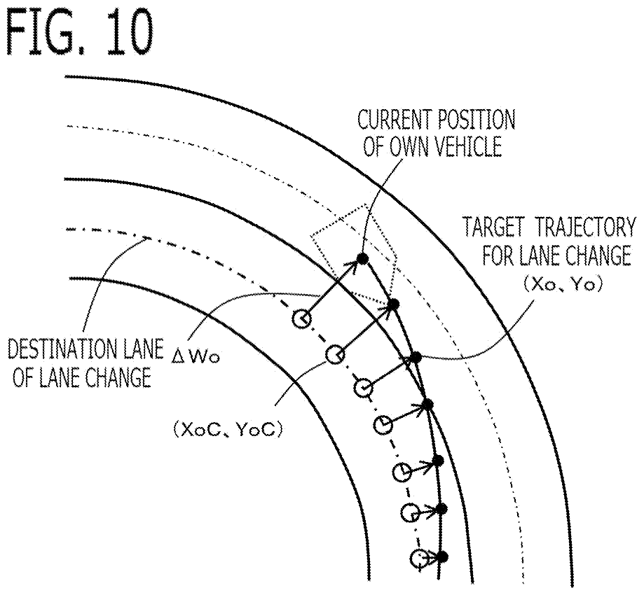

As shown in FIG. 10, the target trajectory generation unit 54 corrects the destination lane of the lane change by the distance of the target trajectory in the lateral direction ΔWo (k) at each time point k of current and future, and generates the target trajectory for the lane change of current and future.

In the present embodiment, the target trajectory generation unit 54 calculates the position Xo (k), Yo (k) of the target trajectory for the lane change at each time point k, by moving the position XoC (k), YoC (k) of the destination lane of the lane change at each time point k, in the lateral direction W (road width direction W) of the position of this lane, by the distance of the target trajectory in the lateral direction ΔWo (k) at each time point k. Specifically, as shown in the next equation, the target trajectory generation unit 54 decomposes the distance of the target trajectory in the lateral direction ΔWo (k) into the longitudinal direction X and the lateral direction Y of the own vehicle coordinate system, based on the inclination angle φ (k) of the tangential direction S of the destination lane of the lane change at each time point k with respect to the longitudinal direction X of the own vehicle coordinate system; adds these to the position XoC (k), YoC (k) of the destination lane of the lane change at each time point k, respectively; and calculates the position Xo (k), Yo (k) of the target trajectory for the lane change at each time point k.

[Equation 18]

Xₒ(k)=X_{oC}(k)+ΔWo(k)sinφ(k)

Yₒ(k)=Y_{oC}(k)+ΔWo(k)cosφ(k) (18)

k=0, . . . , N

By using the next equation, the target trajectory generation unit 54 sets time t (k) at each time point k using the time interval ΔTk between the time points.

[Equation 19]

t(k)=ΔTₖk (19)

k=0, . . . , N

By the correction, the interval of the position of the target trajectory for the lane change at each time point k is changed from the interval of the position of the destination lane of the lane change at each time point k. Then, the target trajectory generation unit 54 may correct the position of the destination lane of the lane change at each time point k so that the interval of the position of the target trajectory for the lane change at each time point k becomes an interval according to the target value of vehicle speed Vo at each time point k.

The target trajectory generation unit 54 sets the target value of vehicle speed Vo (k) which is set in the time series data of the destination lane of the lane change at each time point k, as the target value of vehicle speed Vo (k) of the target trajectory for the lane change at each time point k. The target trajectory generation unit 54 calculates the inclination angle φo (k) of the tangential direction S of the target trajectory at each time point k with respect to the longitudinal direction X of the own vehicle coordinate system, based on the position Xₒ in the longitudinal direction and the position Yo in the lateral direction of the target trajectory at each time point k and before and after of each time point k−1, k+1; and sets a target value of inclination θo (k) of the own vehicle at each time point k with respect to the longitudinal direction X of the own vehicle coordinate system, based on the inclination angle φo (k) of the tangential direction at each time point k. For example, a positive/negative reversing value of the inclination angle φo (k) of the tangential direction at each time point k is set as the target value of inclination θo (k) of the own vehicle at each time point k (θo(k)=−φo (k)).

### <Flowchart>

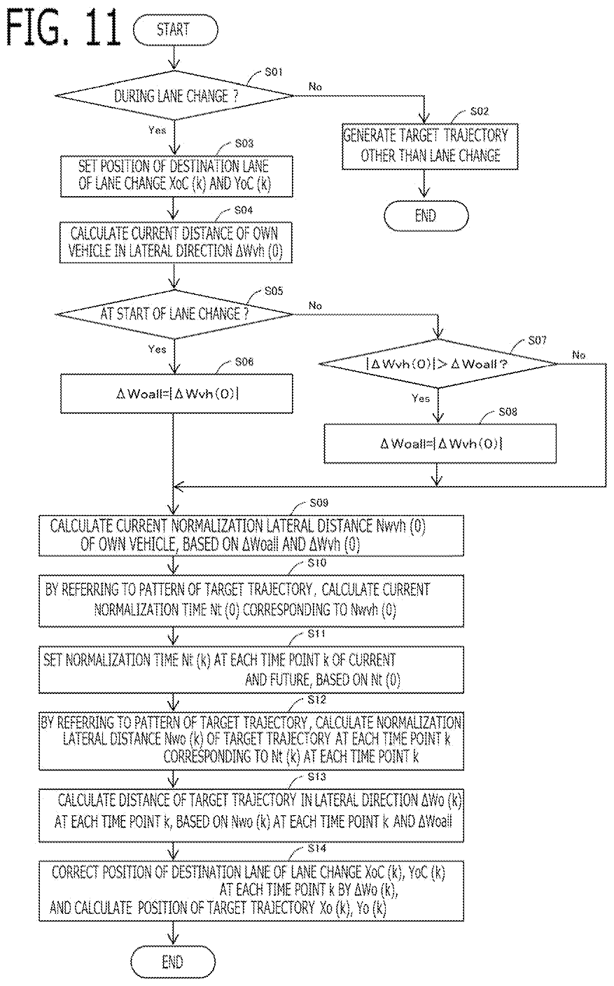

Processing of the target trajectory generation unit 54 explained above can be configured as the flowchart of FIG. 11. Processing of FIG. 11 is executed at every calculation period.

In the step S01, the target trajectory generation unit 54 determines whether or not it is during generation of the target trajectory for the lane change. When it is during generation, it advances to the step S03, and when it is not during generation, it advances to the step S02 and generates the target trajectory other than the lane change.

In the step S03, as mentioned above, the target trajectory generation unit 54 sets the position of the destination lane of the lane change. In the present embodiment, the target trajectory generation unit 54 sets the position XoC (k), YoC (k) of the destination lane of the lane change at each time point k.

In the step S04, as mentioned above, the target trajectory generation unit 54 calculates the current distance of the own vehicle in the lateral direction ΔWvh (0) with respect to the destination lane of the lane change, based on the current position of the own vehicle and the position of the destination lane of the lane change.

In the step S05, the target trajectory generation unit 54 determines whether or not it is at the generation start of the target trajectory for the lane change. When it is at the generation start, it advances to the step S06, and when it is not at the generation start, it advances to the step S07. In the step S06, the target trajectory generation unit 54 calculates the absolute value of the current distance of the own vehicle in the lateral direction ΔWvh (0), as the initial required lateral distance for the lane change ΔWoall. On the other hand, in the step S07, the target trajectory generation unit 54 determines whether or not the absolute value of the current distance of the own vehicle in the lateral direction ΔWvh (0) exceeds the required lateral distance for the lane change ΔWoall which is set currently. When it exceeds, it advances to the step S08 and sets the absolute value of the current distance of the own vehicle in the lateral direction ΔWvh (0), as the required lateral distance for the lane change ΔWoall.

Then, in the step S09, as mentioned above, the target trajectory generation unit 54 calculates the current normalization lateral distance Nwvh (0) of the own vehicle, based on the required lateral distance for the lane change ΔWoall and the current distance of the own vehicle in the lateral direction ΔWvh (0). In the step S10, as mentioned above, by referring to the pattern of the target trajectory, the target trajectory generation unit 54 calculates the current normalization time Nt (0) corresponding to the current normalization lateral distance Nwvh (0) of the own vehicle.

In the step S11, as mentioned above, the target trajectory generation unit 54 sets the normalization time Nt (k) at each time point k of current and future, based on the current normalization time Nt (0). In the step S12, as mentioned above, by referring to the pattern of the target trajectory, the target trajectory generation unit 54 calculates the normalization lateral distance Nwo (k) of the target trajectory at each time point k of current and future corresponding to the normalization time Nt (k) at each time point k of current and future.

In the step S13, as mentioned above, the target trajectory generation unit 54 calculates the distance of the target trajectory in the lateral direction ΔWo (k) at each time point k of current and future, based on the normalization lateral distance Nwo (k) of the target trajectory at each time point k of current and future, and the required lateral distance for the lane change ΔWoall. In the step S14, as mentioned above, the target trajectory generation unit 54 corrects the position XoC (k), YoC (k) of the destination lane of the lane change at each time point k, by the distance of the target trajectory in the lateral direction ΔWo (k) at each time point k; and calculates the position Xₒ (k), Yo (k) of the target trajectory for the lane change at each time point k. The target trajectory generation unit 54 sets the target value of vehicle speed Vo (k) and the target value of inclination θo (k) of the own vehicle at each time point k.

### <Example of Generation of Target Trajectory for Lane Change>

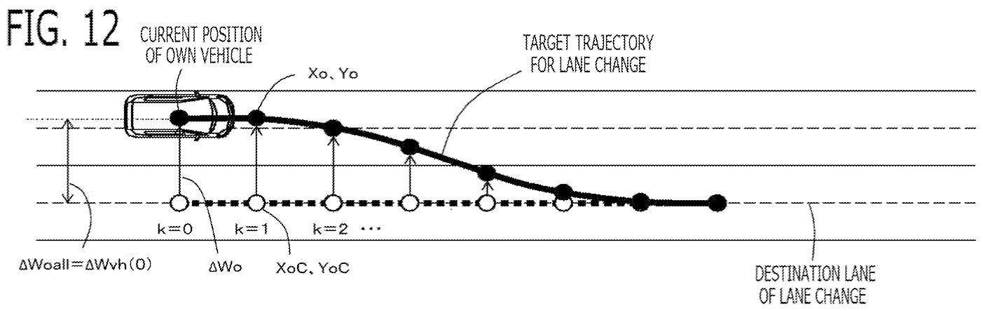

FIG. 12 shows an example of generation of the target trajectory at the start of the lane change to the right side lane on the straight road. Each point in the figure corresponds to each time point k. Since it is at the start of the lane change, the current distance of the own vehicle in the lateral direction W ΔWvh (0) is set as the initial required lateral distance for the lane change ΔWoall, the current normalization lateral distance Nwo (0) of the target trajectory is set to 1, and the current normalization time Nt (0) is set to 0. Then, the normalization time Nt (k) at each time point k of current and future is set to a value which is increased from 0 by the specified value. Corresponding to it, the distance of the target trajectory in the lateral direction ΔWo (k) at each time point k of current and future is set to change from the required lateral distance for the lane change ΔWoall to 0. Then, the position XoC (k), YoC (k) of the destination lane of the lane change at each time point k is corrected by the distance ΔWo (k) in the lateral direction at each time point k, and the position Xo (k), Yo (k) of the target trajectory for the lane change at each time point k is generated. In this way, at the start of the lane change, the appropriate initial target trajectory for the lane change is generated.

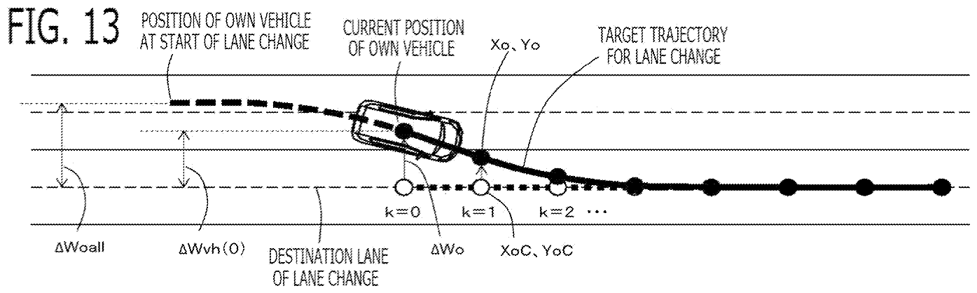

FIG. 13 shows an example of generation of the target trajectory in the middle of the lane change to the right side lane on the straight road. In this example, disturbance, such as the override, does not occur, and the own vehicle is traveling without deviating largely from the initial target trajectory which was set at the start of the lane change. In this case, the current normalization lateral distance Nwo (0) of the target trajectory which is near 0.5 is calculated based on the relation of the current distance of the own vehicle in the lateral direction W ΔWvh (0) with respect to the required lateral distance for the lane change ΔWoall. Corresponding to it, the normalization time Nt (k) at each time point k of current and future is set to a value which is increased from near 0.5 by the specified value; the distance of the target trajectory in the lateral direction ΔWo (k) at each time point k of current and future is set to change from near a half value of the required lateral distance for the lane change ΔWoall to 0; and the target trajectory for the lane change is generated. In this way, when the own vehicle is traveling without deviating largely from the initial target trajectory, the appropriate target trajectory close to the initial target trajectory is consequently generated even by the processing of the present embodiment.

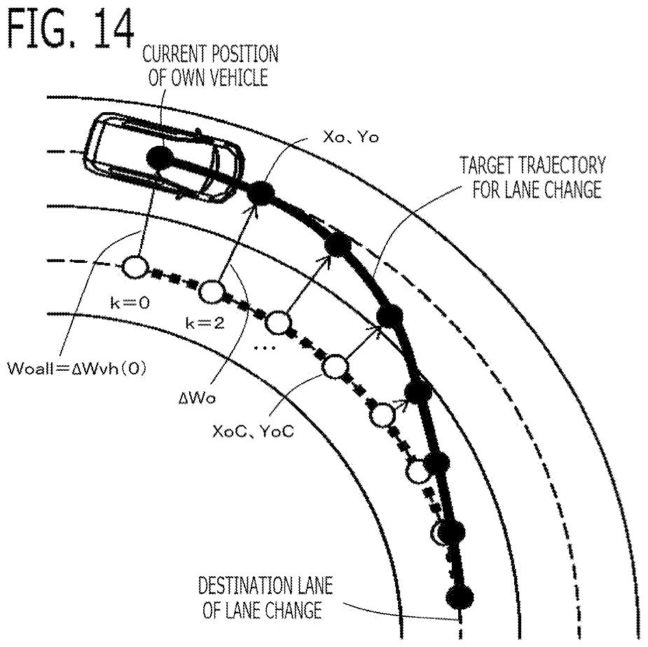

FIG. 14 shows an example of generation of the target trajectory at the start of the lane change to the right side lane on the curve road to the right side. The distance ΔWo (k) in the lateral direction at each time point k is generated similarly to FIG. 12 of the straight road. The position XoC (k), YoC (k) of the destination lane of the lane change at each time point k is moved by the distance of the target trajectory in the lateral direction ΔWo (k) at each time point k, in the lateral direction W (road width direction W) of the position of the destination lane of the lane change curved to the right side at each time point k; and the position of the target trajectory at each time point k is calculated. Accordingly, regardless of the magnitude of the curvature of the curve road, the appropriate analogous target trajectory can be generated.

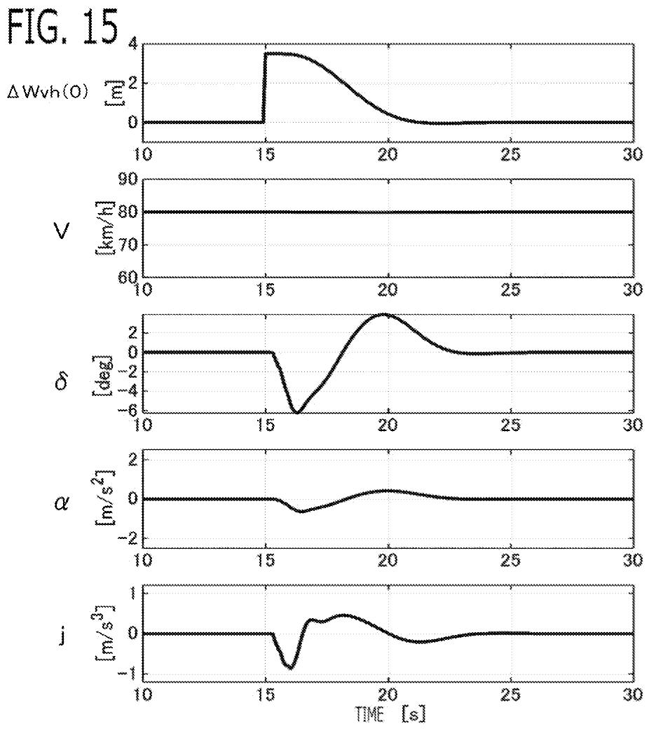

FIG. 15 is a time chart which shows a control behavior of the vehicle when carrying out the lane change on the straight road as shown in FIG. 12. At the time point of 15 seconds, generation of the target trajectory for the lane change is started. Accordingly, the destination lane of the lane change is set to the right side lane, and the current distance of the own vehicle in the lateral direction ΔWvh (0) is increased stepwise. After that, the target trajectory for the lane change as shown in FIG. 12 is set, and the steering angle δ, the acceleration a, and the jerk j are changed for the lane change.

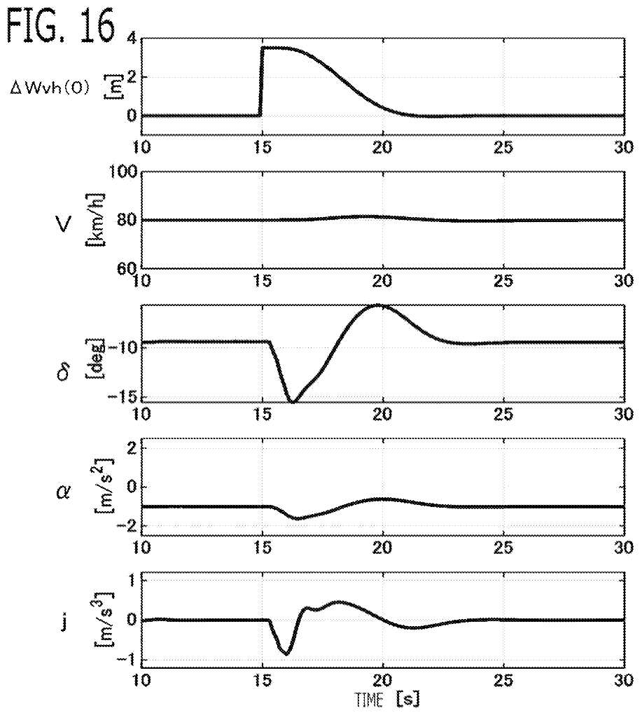

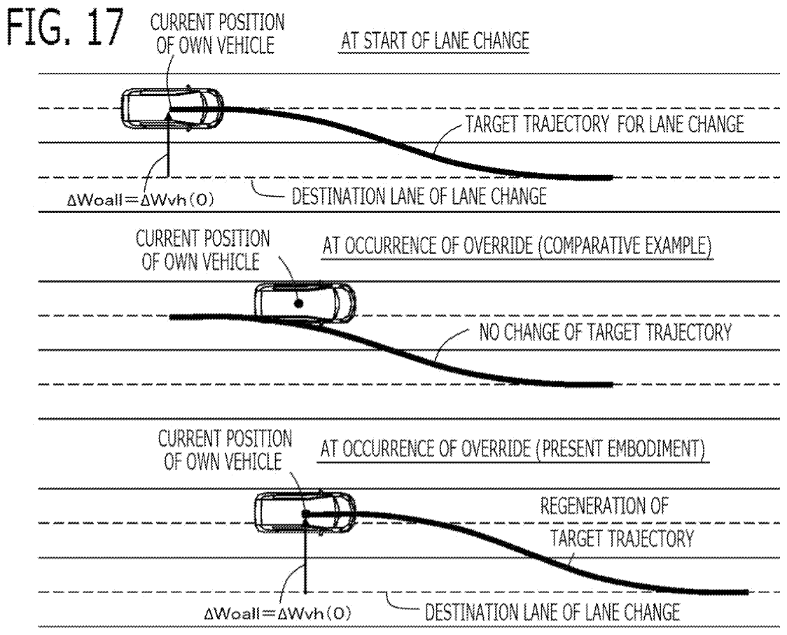

FIG. 16 is a time chart which shows a control behavior of the vehicle when carrying out the lane change on the curve road to the right side as shown in FIG. 13. As mentioned above, by correcting in the lateral direction W (road width direction W) of the position of the destination lane of the lane change, the position of the appropriate analogous target trajectory is calculated regardless of the magnitude of the curvature of the curve road. Accordingly, the waveform of each control value becomes a waveform similar to the case of the straight line road of FIG. 15. Accordingly, the riding comfort of the driver during the lane change can be maintained equivalent, regardless of the straight line road or the curve road.

<Generation of Target Trajectory when there is Override and the Like>

Using FIG. 17, the case where the own vehicle deviates from the initial target trajectory for the lane change due to disturbance, such as the handle operation by the driver (override), the avoidance of the obstacle, or the error of vehicle control will be explained. The figure of the upper stage of FIG. 17 shows the target trajectory generated at the start of the lane change.

The figure of the middle stage of FIG. 17 is a figure related to a comparative example. After the start of the lane change, although the own vehicle deviated from the initial target trajectory due to the override and the like, the target trajectory is not changed from the initial target trajectory unlike the present embodiment. In the case of this comparative example, when the disturbance, such as the override, is ended, the vehicle control is performed from the state where the own vehicle deviated from the initial target trajectory so that the own vehicle follows the initial target trajectory. Accordingly, the vehicle control variable becomes excessive, and the traveling trajectory changes. And, ideal lane change cannot be performed, and the riding comfort is deteriorated.

The figure of the lower stage of FIG. 17 is a figure related to the present embodiment. After the start of the lane change, even when the own vehicle deviated from the initial target trajectory due to the override and the like, the target trajectory for the lane change corresponding to the normalization lateral distance Nwo (k) of the target trajectory at each time point k of current and future is generated. Accordingly, the appropriate trajectory pattern and the lane change period corresponding to the current normalization lateral distance Nwvh (0) of the own vehicle are set. Although the end position of the lane change is moved forward more than the initial position, the riding comfort can be improved. Since the current distance of the own vehicle in the lateral direction W ΔWvh (0) exceeded the initial required lateral distance for the lane change ΔWoall due to deviation, the current distance of the own vehicle in the lateral direction ΔWvh (0) is updated as the required lateral distance for the lane change ΔWoall; the current normalization lateral distance Nwvh (0) is calculated on the basis of the updated required lateral distance for the lane change ΔWoall; and the appropriate target trajectory which passes through the current position of the own vehicle is generated.

### <Flowchart of Control Calculation Apparatus 50>

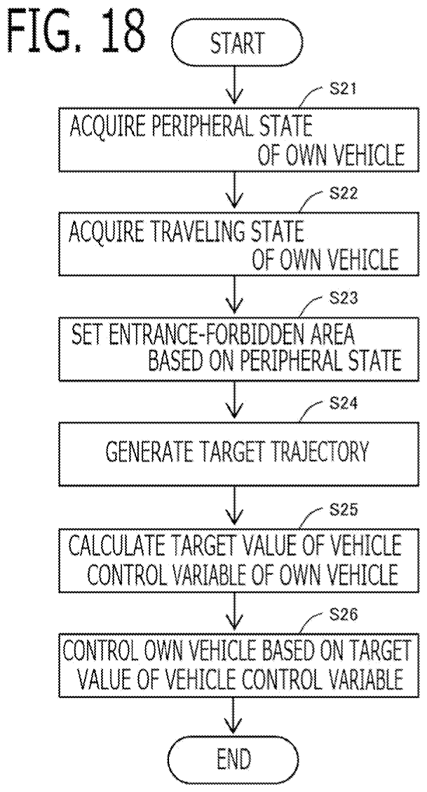

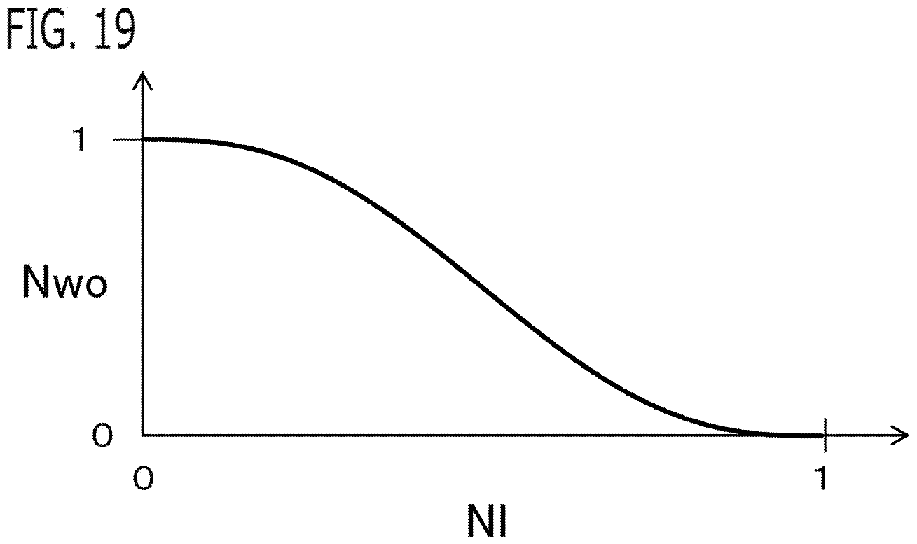

FIG. 18 shows the flowchart for explaining schematic processing of the control calculation apparatus 50. Processing of FIG. 18 is executed at every predetermined calculation period, for example.

In the step S21, as mentioned above, the peripheral state acquisition unit 52 acquires the peripheral state of the own vehicle. In the step S22, as mentioned above, the traveling state acquisition unit 51 acquires the traveling state of the own vehicle. In the step S23, as mentioned above, the entrance-forbidden area setting unit 55 sets an entrance-forbidden area where entrance of the own vehicle is forbidden, based on the peripheral state.

In the step S24, as mentioned above, the decision making unit 53 determines a target behavior of the own vehicle. The target trajectory generation unit 54 generates the target trajectory. The target trajectory generation unit 54 generates the target trajectory for the lane change until the lane change is completed, after the target behavior is changed into the lane change from the lane keeping or the like by the decision making unit 53.

In the step S25, the control variable calculation unit 56 calculates a target value of vehicle control variable of the own vehicle, which includes at least a steering angle δ, for the own vehicle to travel along the target trajectory, based on the traveling state of the own vehicle acquired by the traveling state acquisition unit 51, and the target trajectory generated by the target trajectory generation unit 54. In the step S26, the vehicle control unit 57 controls the own vehicle, based on the target value of vehicle control variable calculated by the control variable calculation unit 56.

### 2. Embodiment 2

The vehicle system 1 and the control calculation apparatus 50 according to Embodiment 2 will be explained with reference to drawings. The explanation for constituent parts the same as those in Embodiment 1 will be omitted. The basic configuration of the vehicle system 1 and the control calculation apparatus 50 according to the present embodiment is the same as that of Embodiment 1. Embodiment 2 is different from Embodiment 1 in a part of processing of the target trajectory generation unit 54.

Even in the present embodiment, after the generation start of the target trajectory for the lane change, the target trajectory generation unit 54 generates the target trajectory for the lane change which passes through a position within a prescribed distance range from the current position of the own vehicle detected based on the traveling state. The target trajectory generation unit 54 uses a pattern of the target trajectory for the lane change which was set in a coordinate system consisting of an axis of time and an axis of a distance of the target trajectory in the lateral direction ΔWo with respect to a destination lane of the lane change; and shifts the pattern of the target trajectory in the time direction so that the pattern of the target trajectory passes through the position within the prescribed distance range from the current position of the own vehicle, and generates the target trajectory for the lane change.

In the present embodiment, unlike Embodiment 1, the target trajectory generation unit 54 calculates a current change speed of the distance of the own vehicle in the lateral direction SWvh (0) with respect to the destination lane of the lane change. Then, by referring to a pattern of a differentiation target trajectory, the target trajectory generation unit 54 calculates current time in the pattern of the target trajectory corresponding to the calculated current change speed of the distance of the own vehicle in the lateral direction SWvh (0). The pattern of the differentiation target trajectory is a pattern that the pattern of the target trajectory which is set in the coordinate system consisting of the axis of time and the axis of the distance of the target trajectory in the lateral direction is transformed into a coordinate system consisting of the axis of time and the axis of the change speed of the distance of the target trajectory in the lateral direction.

Then, similarly to Embodiment 1, by referring to the pattern of the target trajectory, the target trajectory generation unit 54 calculates the distance of the target trajectory in the lateral direction ΔWo (k) at each time point k of current and future corresponding to time at each time point k of current and future after the calculated current time; and generates the target trajectory for the lane change, using the calculated distance of the target trajectory in the lateral direction ΔWo (k) at each time point k of current and future.

According to this configuration, the current time of the current pattern of the target trajectory corresponding to the current change speed of the distance of the own vehicle in the lateral direction SWvh (0), and the distance of the target trajectory in the lateral direction ΔWo corresponding to it can be calculated. Accordingly, the current and subsequent change speed of the target trajectory in the lateral direction can be corresponded to the current change speed of the distance of the own vehicle in the lateral direction SWvh (0). Accordingly, the subsequent change amount of the target value of steering angle δo is suppressed from becoming large, the rapid operation of the steering angle is suppressed from performing, and the riding comfort can be prevented from deteriorating.

In the present embodiment, an axis of the normalization time Nt is used as the axis of time, and an axis of the normalization lateral distance Nwo of the target trajectory is used as the axis of the distance of the target trajectory in the lateral direction. The pattern of the differentiation target trajectory is a pattern that the pattern of the target trajectory which is set in the coordinate system consisting of the axis of the normalization time Nt and the axis of the normalization lateral distance Nwo of the target trajectory is transformed into the coordinate system consisting of the axis of the normalization time Nt and the axis of a change speed of the normalization lateral distance SNwo of the target trajectory.

For example, as shown in the next equation, as the pattern of the differentiation target trajectory, the change speed of the normalization lateral distance SNwo of the target trajectory which is obtained by differentiating the normalization lateral distance Nwo of the target trajectory with respect to the normalization time Nt is used.

$$[ Equation 20 ]$$

$$SNwo = \frac{dNwo}{dNt} = \frac{dfpt ( Nt )}{dNt} \qquad ( 20 )$$

The target trajectory generation unit 54 calculates a current change speed of the normalization lateral distance SNwvh (0) of the own vehicle. The target trajectory generation unit 54 calculates the current change speed of the normalization lateral distance SNwvh (0) of the own vehicle, based on a change amount of the normalization lateral distance Nwvh of the own vehicle per the current time interval ΔTk between the time points.

In the present embodiment, as shown in the next equation, the target trajectory generation unit 54 calculates the current normalization time Nt (0) corresponding to the current change speed of the normalization lateral distance SNwvh (0) of the own vehicle, using an inverse function of the pattern of the differentiation target trajectory of the equation (20). The inverse function is preliminarily set based on the equation (20). The current normalization time Nt (0) is lower-limited by 0, and is upper-limited by 1.

$$[ Equation 21 ]$$

$$Nt ( 0 ) = \frac{{dfpt}^{- 1}}{dNt} ( SNwvh ( 0 ) ) \qquad ( 21 )$$

It is preferable that a relation between the change speed of the normalization lateral distance SNwvh of the own vehicle and the normalization time Nt is bijection. However, even if the relation is not bijection but two normalization times Nt or more corresponding to the current change speed of the normalization lateral distance SNwvh (0) of the own vehicle exist, the normalization times Nt corresponding to the current normalization lateral distance Nwo (0) of the target trajectory are calculated by referring to the pattern of the target trajectory, and the normalization time Nt closest to the calculated normalization time Nt may be selected.

Then, similarly to Embodiment 1, by referring to the pattern of the target trajectory, the target trajectory generation unit 54 calculates the normalization lateral distance Nwo (k) of the target trajectory at each time point k of current and future corresponding to the normalization time Nt (k) at each time point k of current and future after the calculated current normalization time Nt (0); and generates the target trajectory for the lane change, using the calculated normalization lateral distance Nwo (k) of the target trajectory at each time point k of current and future, and the required lateral distance for the lane change ΔWoall.

In the present embodiment, although the generated target trajectory for the lane change does not always pass through the current position of the own vehicle (representative position), it passes through near the current position of the own vehicle. Accordingly, even when the own vehicle deviates from the target trajectory due to disturbance, such as the override, the appropriate target trajectory can be generated.

### 3. Embodiment 3

The vehicle system 1 and the control calculation apparatus 50 according to Embodiment 3 will be explained with reference to drawings. The explanation for constituent parts the same as those in Embodiment 1 will be omitted. The basic configuration of the vehicle system 1 and the control calculation apparatus 50 according to the present embodiment is the same as that of Embodiment 1. Embodiment 3 is different from Embodiment 1 in a part of processing of the target trajectory generation unit 54.

Even in the present embodiment, after the generation start of the target trajectory for the lane change, the target trajectory generation unit 54 generates the target trajectory for the lane change which passes through a position within a prescribed distance range from the current position of the own vehicle detected based on the traveling state. And, the position within the prescribed distance range from the current position of the own vehicle is set to a position within a range where the current own vehicle is projected on the road. For example, the position within the prescribed distance range is set to the representative position of the own vehicle, such as the gravity center or the neutral steer point.

Unlike Embodiment 1, the target trajectory generation unit 54 uses a pattern of the target trajectory for the lane change which was set in a coordinate system consisting of an axis of a traveling distance of the own vehicle and an axis of a distance of the target trajectory in the lateral direction ΔWo with respect to the destination lane of the lane change; and shifts the pattern of the target trajectory in a direction of traveling distance so that the pattern of the target trajectory passes through the position within the prescribed distance range, and generates the target trajectory for the lane change.

According to this configuration, similarly to Embodiment 1, due to disturbance, such as the handle operation (override) by the driver, even if the own vehicle deviates from the initial target trajectory for the lane change, the pattern of the target trajectory is shifted in the direction of traveling distance so that the pattern of the target trajectory passes through the position (in this example, the current position of the own vehicle) within the prescribed distance range from the current position of the own vehicle corresponding to the state of deviating, and the target trajectory is generated. Accordingly, since the pattern of the target trajectory which passes through the position within the prescribed distance range from the current position of the own vehicle is used, the riding comfort which was supposed with the pattern of the target trajectory can be suppressed from deteriorating. In the present embodiment, the distance of the target trajectory in the lateral direction ΔWo is managed by the axis of the traveling distance of the own vehicle, not by the axis of time of Embodiment 1. Accordingly, even when the traveling distance per unit time increases or decreases by acceleration or deceleration during the lane change, the appropriate target trajectory for the lane change according to the traveling distance can be generated.

### <Traveling Distance Shift Based on Current Distance of Own Vehicle in Lateral Direction ΔWvh (0)>

In the present embodiment, the target trajectory generation unit 54 calculates a current distance of the own vehicle in the lateral direction ΔWvh (0) with respect to the destination lane of the lane change, based on the traveling state; by referring to the pattern of the target trajectory, calculates the current traveling distance in the pattern of the target trajectory corresponding to the current distance of the own vehicle in the lateral direction ΔWvh (0); by referring to the pattern of the target trajectory, calculates the distance of the target trajectory in the lateral direction ΔWo (k) at each time point k of current and future corresponding to the traveling distance at each time point k of current and future after the calculated current traveling distance; and generates the target trajectory for the lane change, using the calculated distance of the target trajectory in the lateral direction ΔWo (k) at each time point k of current and future.

According to this configuration, the corresponding traveling distance at each time point k of current and future k in the pattern of the target trajectory is calculated based on the current distance of the own vehicle in the lateral direction ΔWvh (0), and the corresponding distance of the target trajectory in the lateral direction ΔWo (k) at each time point k of current and future in the pattern of the target trajectory can be calculated. Accordingly, by the current distance of the own vehicle in the lateral direction ΔWvh (0), the pattern of the target trajectory is rationally and accurately shifted in the direction of traveling distance so as to pass through the current position of the own vehicle, and the target trajectory can be generated.

### <Setting of Pattern of Target Trajectory by Normalization Traveling Distance Nl and Normalization Lateral Distance Nwo>

In the present embodiment, an axis of the normalization traveling distance Nl is used as the axis of the traveling distance, and an axis of the normalization lateral distance Nwo of the target trajectory is used as the axis of the distance of the target trajectory in the lateral direction. Accordingly, as shown in FIG. 19, the pattern of the target trajectory is preliminarily set in a coordinate system consisting of the axis of the normalization traveling distance Nl and the axis of the normalization lateral distance Nwo of the target trajectory. Herein, the normalization traveling distance Nl is one that the traveling distance is normalized by a required traveling distance for the lane change ΔLcl corresponding to a total traveling distance of the pattern of the target trajectory. The normalization lateral distance Nwo of the target trajectory is one that the distance of the target trajectory in the lateral direction ΔWo is normalized by a required lateral distance for the lane change ΔWoall corresponding to a total distance of the pattern of the target trajectory in the lateral direction.

Then, by referring to the pattern of the target trajectory, the target trajectory generation unit 54 calculates the current normalization traveling distance Nl (0) corresponding to a current normalization lateral distance Nwvh (0) of the own vehicle that the current distance of the own vehicle in the lateral direction ΔWvh (0) is normalized by the required lateral distance for the lane change ΔWoall; by referring to the pattern of the target trajectory, calculates the normalization lateral distance Nwo (k) of the target trajectory at each time point k of current and future corresponding to the normalization traveling distance Nl (k) at each time point k of current and future after the calculated current normalization traveling distance Nl (0); and generates the target trajectory for the lane change, using the calculated normalization lateral distance Nwo (k) of the target trajectory at each time point k of current and future, and the required lateral distance for the lane change ΔWoall.

Using the same method as Embodiment 1, the target trajectory generation unit 54 calculates the current normalization lateral distance Nwvh (0) of the own vehicle.

In the present embodiment, as the pattern of the target trajectory, the target trajectory generation unit 54 uses a polynomial in which the normalization traveling distance Nl is set as an independent variable, and the normalization lateral distance Nwo of the target trajectory is set as a dependent variable. For example, the next equation which replaced the normalization time Nt of the equation (13) by the normalization traveling distance Nl is used. Herein, fpl is a function expressing the pattern of the target trajectory. Besides the polynomial, an arbitrary function, such as map data, may be used as the pattern of the target trajectory. The pattern of the target trajectory has characteristics that Nwo=1 at Nl=0, Nwo=0 at Nl=1, and Nwo decreases monotonically from 1 to 0 as Nl increases from 0 to 1.

[Equation 22]

Nwo=fpl(N)=1−(6Nl⁵−15Nl⁴+10Nl³) (22)

Similarly to the equation (13), in the equation (22), since a differential value dNwo/dNI which is obtained by differentiating the normalization lateral distance Nwo of the target trajectory with respect to the normalization traveling distance Nl becomes 0 at the start Nl=0 and the completion Nl=1 of the lane change, the target trajectory for the lane change and the lanes before and after the lane change are connected smoothly, and the riding comfort during the lane change is improved. An arbitrary function besides the equation (22) may be used.

### <Calculation of Current Normalization Traveling Distance Nl (0)>

As mentioned above, by referring to the pattern of the target trajectory, the target trajectory generation unit 54 calculates the current normalization traveling distance Nl (0) corresponding to the current normalization lateral distance Nwvh (0) of the own vehicle.

In the present embodiment, as shown in the next equation, the target trajectory generation unit 54 calculates the current normalization traveling distance Nl (0) corresponding to the current normalization lateral distance Nwvh (0) of the own vehicle, using an inverse function fpl⁻¹ of the pattern of the target trajectory of the equation (22). The inverse function fpl⁻¹ is preliminarily set based on the equation (22). The current normalization traveling distance Nl (0) is lower-limited by 0, and is upper-limited by 1.

[Equation 23]

Nl(0)=fpl⁻¹(Nwvh(0)) (23)

### <Calculation of Normalization Traveling Distance Nl (k) at Each Time Point k of Current and Future>

The target trajectory generation unit 54 sets the required traveling distance for the lane change ΔLcl, based on the vehicle speed, the peripheral state, the road shape, and the like. The traveling distance is a traveling distance along the tangential direction S of the destination lane of the lane change. The required traveling distance for the lane change ΔLcl may be set considering a remaining distance of a merging section or a diverging section. Since the required traveling distance for the lane change ΔLcl can be designated explicitly, even when a section where the lane change can be performed in the merging section or the diverging section is finite, the lane change can be performed certainly.

The target trajectory generation unit 54 sets the normalization traveling distance Nl (k) at each time point k of current and future after the current normalization traveling distance Nl (0). For example, as shown in the next equation, as the time point k increases from 0, the target trajectory generation unit 54 increases the normalization traveling distance Nl (k) by the change amount of the normalization traveling distance ΔNl (k) in the time interval ΔTk between the time points, from Nl (0), and the normalization traveling distance Nl (k) at each time point k of current and future. The target trajectory generation unit 54 upper-limits the normalization traveling distance Nl (k) by 1 of the maximum value. The target trajectory generation unit 54 calculates the change amount of the normalization traveling distance ΔNl (k) at each time point k, by multiplying the time interval ΔTk to the target value of vehicle speed Vo (k) at each time point k, and dividing by the required traveling distance for the lane change ΔLcl.

$$[ Equation 24 ]$$

$$Nl ( k + 1 ) = Nl ( k ) + Δ Nl ( k ) \\ Δ Nl ( k ) = \frac{Vo ( k ) Δ {T}_{k}}{Δ {L}_{cl}} \\ Nl ( k ) \leq 1 , k = 0 , … , N \qquad ( 24 )$$

The target value of vehicle speed Vo (k) at each time point k is calculated based on a vehicle speed schedule during the lane change. For example, the target trajectory generation unit 54 sets the vehicle speed schedule in which a relation between the normalization traveling distance Nl and the target value of vehicle speed Vo is set, based on the current vehicle speed and the target value of vehicle speed Vo at the end of the lane change; and calculates the target value of vehicle speed Vo (k) corresponding to the normalization traveling distance Nl (k) at each time point k, using the vehicle speed schedule.

In the present embodiment, the target value of vehicle speed Vo (k) of the equation (9) of Embodiment 1 is changed based on the vehicle speed schedule; and the position XoC (k), YoC (k) of the destination lane of the lane change at each time point k is calculated.

### <Calculation of Normalization Lateral Distance Nwo (k) of Target Trajectory at Each Time Point k of Current and Future>

As mentioned above, by referring to the pattern of the target trajectory, the target trajectory generation unit 54 calculates the normalization lateral distance Nwo (k) of the target trajectory at each time point k of current and future corresponding to the normalization traveling distance Nl (k) at each time point k of current and future.

In the present embodiment, about each time point k=0, . . . , N, by using the pattern of the target trajectory of the equation (22) as shown in the next equation, the target trajectory generation unit 54 calculates the normalization lateral distance Nwo (k) of the target trajectory at each time point k corresponding to the normalization traveling distance Nl (k) at each time point k. The normalization lateral distance Nwo (k) of the target trajectory at each time point k is lower-limited by 0, and is upper-limited by 1.

[Equation 25]

Nwo(k)=fpl(Nl(k))=1−(6Nl(k)⁵−15Nl(k)⁴+10Nl(k)³)0≤Nwo(k)≤1 (25)

k=0, . . . , N

Since the calculation processing of the distance of the target trajectory in the lateral direction ΔWo (k) at each time point k of current and future based on the normalization lateral distance Nwo (k) of the target trajectory at each time point k of current and future and the required lateral distance for the lane change ΔWoall, and the calculation processing of the target trajectory for the lane change at each time point k of current and future are the same as those of Embodiment 1, explanation is omitted.

### <The Example of Generation of the Target Trajectory at the Time of Acceleration>

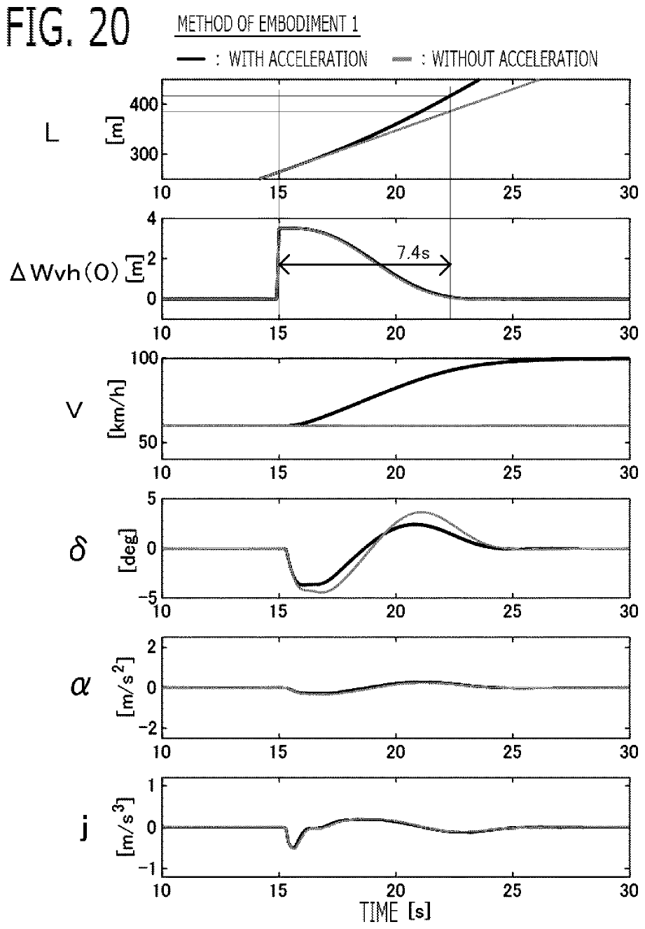

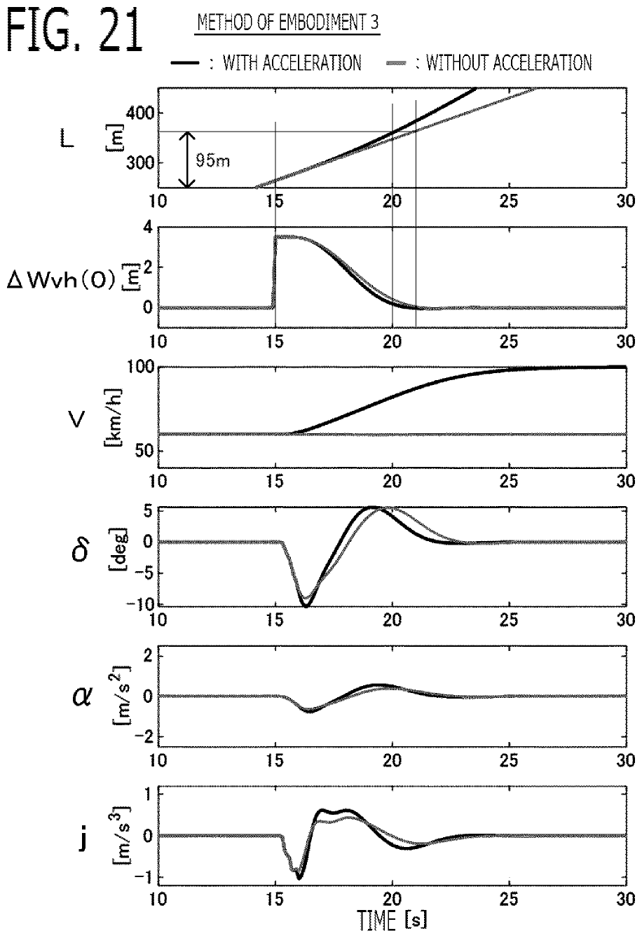

FIG. 20 and FIG. 21 are time charts which show a control behavior of the vehicle when the target value of vehicle speed Vo increases during the lane change on the straight line road (solid line) and when it is a constant (dotted line). The graphs of the upper stage of FIG. 20 and FIG. 21 shows the traveling distance L of the own vehicle. When the target value of vehicle speed Vo increases, it is increased from 60 km/h at the start of the lane change to 100 km/h. FIG. 20 shows the case where the lane change is performed by the method described in Embodiment 1, and the required time for the lane change ΔTcl is set to 8 sec. FIG. 21 shows the case where the lane change is performed by the method described in Embodiment 3, and the required traveling distance for the lane change ΔLcl is set to 100 meters.

If the lane change is completed when the distance of the own vehicle in the lateral direction ΔWvh (0) becomes 0.1 meter or less, since the required time for the lane change ΔTcl can be designated in FIG. 20, the lane change is completed approximately at 8 sec of the setting value. However, between the case where the target value of vehicle speed Vo increases, and the case where it is a constant, the traveling distances L required for the lane change are different. On the other hand, in FIG. 21, between the case where the target value Vo increases, and the case where it is a constant, the times required for the lane change are different, but the traveling distances L required for the lane change become 95 meters almost equal to the setting value. In this way, the required traveling distance for the lane change ΔTcl can be designated by the method of Embodiment 3. And, even when a section where the lane change can be performed in the merging section or the diverging section is finite, the lane change can be performed certainly.

### <Summary of Aspects of Present Disclosure>

Hereinafter, the aspects of the present disclosure is summarized as appendices.

### (Appendix 1)

A control calculation apparatus, comprising:
a traveling state acquisition unit that acquires a traveling state of an own vehicle;
a target trajectory generation unit that generates a target trajectory of the own vehicle; and
a control variable calculation unit that calculates a target value of a vehicle control variable, which includes at least a steering angle, for the own vehicle to travel along the target trajectory, based on the traveling state and the target trajectory,
wherein, after generation start of the target trajectory for a lane change, the target trajectory generation unit generates the target trajectory for the lane change which passes through a position within a prescribed distance range from a current position of the own vehicle detected based on the traveling state.

### (Appendix 2)

The control calculation apparatus according to appendix 1,
wherein the position within the prescribed distance range is set to a position within a range where the current own vehicle is projected on a road.

### (Appendix 3)

The control calculation apparatus according to appendix 1 or 2,
wherein the target trajectory generation unit uses a pattern of the target trajectory for the lane change which was set in a coordinate system consisting of an axis of time and an axis of a distance of the target trajectory in a lateral direction with respect to a destination lane of the lane change; and
shifts the pattern of the target trajectory in a time direction so that the pattern of the target trajectory passes through the position within the prescribed distance range.

### (Appendix 4)

The control calculation apparatus according to appendix 3,
wherein the target trajectory generation unit calculates a current distance of the own vehicle in the lateral direction with respect to the destination lane of the lane change, based on the traveling state;
by referring to the pattern of the target trajectory, calculates current time in the pattern of the target trajectory corresponding to the current distance of the own vehicle in the lateral direction;
by referring to the pattern of the target trajectory, calculates a distance of the target trajectory in the lateral direction at each time point of current and future which corresponds to time at each time point of current and future after the calculated current time; and generates the target trajectory for the lane change using the calculated distance of the target trajectory in the lateral direction at each time point of current and future.

### (Appendix 5)

The control calculation apparatus according to appendix 3,
wherein, in the pattern of the target trajectory, as the axis of time, an axis of a normalization time that time is normalized by a required time for the lane change corresponding to a total time of the pattern of the target trajectory is used; and
as the axis of the distance of the target trajectory in the lateral direction, an axis of a normalization lateral distance of the target trajectory that the distance of the target trajectory in the lateral direction is normalized by a required lateral distance for the lane change corresponding to a total distance of the pattern of the target trajectory in the lateral direction is used,
wherein, by referring to the pattern of the target trajectory, the target trajectory generation unit calculates the current normalization time in the pattern of the target trajectory corresponding to a current normalization lateral distance of the own vehicle that the current distance of the own vehicle in the lateral direction is normalized by the required lateral distance for the lane change;
by referring to the pattern of the target trajectory, calculates the normalization lateral distance of the target trajectory at each time point of current and future corresponding to the normalization time at each time point of current and future after the calculated current normalization time; and
generates the target trajectory for the lane change, using the calculated normalization lateral distance of the target trajectory at each time point of current and future, and the required lateral distance for the lane change.

### (Appendix 6)

The control calculation apparatus according to appendix 3,
wherein the target trajectory generation unit calculates a current change speed of the distance of the own vehicle in the lateral direction with respect to the destination lane of the lane change, based on the traveling state;
by referring to a pattern of a differentiation target trajectory that the pattern of the target trajectory is transformed into a coordinate system consisting of the axis of time and an axis of the change speed of the distance of the target trajectory in the lateral direction, calculates current time in the pattern of the target trajectory corresponding to the calculated current change speed of the distance of the own vehicle in the lateral direction;
by referring to the pattern of the target trajectory, calculates the distance of the target trajectory in the lateral direction at each time point of current and future corresponding to time at each time point of current and future after the calculated current time; and
generates the target trajectory for the lane change, using the calculated distance of the target trajectory in the lateral direction at each time point of current and future.

### (Appendix 7)

The control calculation apparatus according to appendix 1 or 2,
wherein the target trajectory generation unit uses a pattern of the target trajectory for the lane change which was set in a coordinate system consisting of an axis of a traveling distance of the own vehicle and an axis of a distance of the target trajectory in a lateral direction with respect to a destination lane of the lane change; and
shifts the pattern of the target trajectory in a direction of traveling distance so that the pattern of the target trajectory passes through the position within the prescribed distance range.

### (Appendix 8)

The control calculation apparatus according to appendix 7,
wherein the target trajectory generation unit calculates a current distance of the own vehicle in the lateral direction with respect to the destination lane of the lane change, based on the traveling state;
by referring to the pattern of the target trajectory, calculates the current traveling distance in the pattern of the target trajectory corresponding to the current distance of the own vehicle in the lateral direction;
by referring to the pattern of the target trajectory, calculates the distance of the target trajectory in the lateral direction at each time point of current and future corresponding to the traveling distance at each time point of current and future after the calculated current traveling distance; and
generates the target trajectory for the lane change, using the calculated distance of the target trajectory in the lateral direction at each time point of current and future.

### (Appendix 9)

The control calculation apparatus according to appendix 7,
wherein, in the pattern of the target trajectory, as the axis of the traveling distance, an axis of a normalization traveling distance that the traveling distance is normalized by a required traveling distance for the lane change corresponding to a total traveling distance of the pattern of the target trajectory is used; and as the axis of the distance of the target trajectory in the lateral direction, an axis of a normalization lateral distance of the target trajectory that the distance of the target trajectory in the lateral direction is normalized by a required lateral distance for the lane change corresponding to a total distance of the pattern of the target trajectory in the lateral direction is used,
by referring to the pattern of the target trajectory, the target trajectory generation unit calculates the current normalization traveling distance in the pattern of the target trajectory corresponding to a current normalization lateral distance of the own vehicle that the current distance of the own vehicle in the lateral direction is normalized by the required lateral distance for the lane change;
by referring to the pattern of the target trajectory, calculates the normalization lateral distance of the target trajectory at each time point of current and future corresponding to the normalization traveling distance at each time point of current and future after the calculated current normalization traveling distance; and
generates the target trajectory for the lane change, using the calculated normalization lateral distance of the target trajectory at each time point of current and future, and the required lateral distance for the lane change.

### (Appendix 10)

The control calculation apparatus according to any one of appendices 4 to 9,
wherein the target trajectory generation unit corrects position of the destination lane of the lane change by the distance of the target trajectory in the lateral direction at each time point of current and future, and generates the target trajectory for the lane change.

### (Appendix 11)

The control calculation apparatus according to any one of appendices 1 to 10,
wherein the target trajectory generation unit uses a road width direction at each position of the destination lane of the lane change, as the lateral direction.

### (Appendix 12)

The control calculation apparatus according to appendix 5,
wherein the target trajectory generation unit uses, as the pattern of the target trajectory, a polynomial in which the normalization time is set as an independent variable, and the normalization lateral distance of the target trajectory is set as a dependent variable.

### (Appendix 13)

The control calculation apparatus according to appendix 12,
wherein, by defining the normalization time as Nt, and defining the normalization lateral distance of the target trajectory as Nwo, the target trajectory generation unit uses, as the pattern of the target trajectory,

Nwo=1−(6×Nt⁵−15×Nt⁴+10×Nt³).

### (Appendix 14)

The control calculation apparatus according to appendix 5 or 9,
wherein the target trajectory generation unit sets the current distance of the own vehicle in the lateral direction with respect to the destination lane of the lane change at generation start of the target trajectory for the lane change, as the initial required lateral distance for the lane change; and
after the generation start, when the current distance of the own vehicle in the lateral direction exceeds the required lateral distance for the lane change which is set currently, the target trajectory generation unit sets the current distance of the own vehicle in the lateral direction, as the required lateral distance for the lane change.

### (Appendix 15)

The control calculation apparatus according to any one of appendices 1 to 14, further comprising:
a peripheral state acquisition unit that acquires a peripheral state of the own vehicle; and
an entrance-forbidden area setting unit that sets an entrance-forbidden area where entrance of the own vehicle is forbidden, based on the peripheral state,
wherein, under a constraint condition that the own vehicle does not enter into the entrance-forbidden area, the control variable calculation unit calculates a target value of vehicle control variable for the own vehicle to travel along the target trajectory, based on the traveling state and the target trajectory.

Although the present disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments. It is therefore understood that numerous modifications which have not been exemplified can be devised without departing from the scope of the present disclosure. For example, at least one of the constituent components may be modified, added, or eliminated. At least one of the constituent components mentioned in at least one of the preferred embodiments may be selected and combined with the constituent components mentioned in another preferred embodiment.

What is claimed is:

1. A control calculation apparatus, comprising at least one processor configured to implement:
a traveling state acquisitor that acquires a traveling state of an own vehicle;
a target trajectory generator that generates a target trajectory of the own vehicle; and
a control variable calculator that calculates a target value of a vehicle control variable, which includes at least a steering angle, for the own vehicle to travel along the target trajectory, based on the traveling state and the target trajectory,
wherein, after generation start of the target trajectory for a lane change, the target trajectory generator generates the target trajectory for the lane change which passes through a position within a prescribed distance range from a current position of the own vehicle detected based on the traveling state.

2. The control calculation apparatus according to claim 1,
wherein the position within the prescribed distance range is set to a position within a range where the current own vehicle is projected on a road.

3. The control calculation apparatus according to claim 1,
wherein the target trajectory generator uses a pattern of the target trajectory for the lane change which was set in a coordinate system consisting of an axis of time and an axis of a distance of the target trajectory in a lateral direction with respect to a destination lane of the lane change; and
shifts the pattern of the target trajectory in a time direction so that the pattern of the target trajectory passes through the position within the prescribed distance range.

4. The control calculation apparatus according to claim 3,
wherein the target trajectory generator calculates a current distance of the own vehicle in the lateral direction with respect to the destination lane of the lane change, based on the traveling state;
by referring to the pattern of the target trajectory, calculates current time in the pattern of the target trajectory corresponding to the current distance of the own vehicle in the lateral direction;
by referring to the pattern of the target trajectory, calculates a distance of the target trajectory in the lateral direction at each time point of current and future which corresponds to time at each time point of current and future after the calculated current time; and generates the target trajectory for the lane change using the calculated distance of the target trajectory in the lateral direction at each time point of current and future.

5. The control calculation apparatus according to claim 3,
wherein, in the pattern of the target trajectory, as the axis of time, an axis of a normalization time that time is normalized by a required time for the lane change corresponding to a total time of the pattern of the target trajectory is used; and
as the axis of the distance of the target trajectory in the lateral direction, an axis of a normalization lateral distance of the target trajectory that the distance of the target trajectory in the lateral direction is normalized by a required lateral distance for the lane change corresponding to a total distance of the pattern of the target trajectory in the lateral direction is used,
wherein, by referring to the pattern of the target trajectory, the target trajectory generator calculates the current normalization time in the pattern of the target trajectory corresponding to a current normalization lateral distance of the own vehicle that the current distance of the own vehicle in the lateral direction is normalized by the required lateral distance for the lane change;
by referring to the pattern of the target trajectory, calculates the normalization lateral distance of the target trajectory at each time point of current and future corresponding to the normalization time at each time point of current and future after the calculated current normalization time; and
generates the target trajectory for the lane change, using the calculated normalization lateral distance of the target trajectory at each time point of current and future, and the required lateral distance for the lane change.

6. The control calculation apparatus according to claim 3,
wherein the target trajectory generator calculates a current change speed of the distance of the own vehicle in the lateral direction with respect to the destination lane of the lane change, based on the traveling state;
by referring to a pattern of a differentiation target trajectory that the pattern of the target trajectory is transformed into a coordinate system consisting of the axis of time and an axis of the change speed of the distance of the target trajectory in the lateral direction, calculates current time in the pattern of the target trajectory corresponding to the calculated current change speed of the distance of the own vehicle in the lateral direction;
by referring to the pattern of the target trajectory, calculates the distance of the target trajectory in the lateral direction at each time point of current and future corresponding to time at each time point of current and future after the calculated current time; and
generates the target trajectory for the lane change, using the calculated distance of the target trajectory in the lateral direction at each time point of current and future.

7. The control calculation apparatus according to claim 1,
wherein the target trajectory generator uses a pattern of the target trajectory for the lane change which was set in a coordinate system consisting of an axis of a traveling distance of the own vehicle and an axis of a distance of the target trajectory in a lateral direction with respect to a destination lane of the lane change; and
shifts the pattern of the target trajectory in a direction of traveling distance so that the pattern of the target trajectory passes through the position within the prescribed distance range.

8. The control calculation apparatus according to claim 7,
wherein the target trajectory generator calculates a current distance of the own vehicle in the lateral direction with respect to the destination lane of the lane change, based on the traveling state;
by referring to the pattern of the target trajectory, calculates the current traveling distance in the pattern of the target trajectory corresponding to the current distance of the own vehicle in the lateral direction;
by referring to the pattern of the target trajectory, calculates the distance of the target trajectory in the lateral direction at each time point of current and future corresponding to the traveling distance at each time point of current and future after the calculated current traveling distance; and
generates the target trajectory for the lane change, using the calculated distance of the target trajectory in the lateral direction at each time point of current and future.

9. The control calculation apparatus according to claim 7,
wherein, in the pattern of the target trajectory, as the axis of the traveling distance, an axis of a normalization traveling distance that the traveling distance is normalized by a required traveling distance for the lane change corresponding to a total traveling distance of the pattern of the target trajectory is used; and as the axis of the distance of the target trajectory in the lateral direction, an axis of a normalization lateral distance of the target trajectory that the distance of the target trajectory in the lateral direction is normalized by a required lateral distance for the lane change corresponding to a total distance of the pattern of the target trajectory in the lateral direction is used,
by referring to the pattern of the target trajectory, the target trajectory generator calculates the current normalization traveling distance in the pattern of the target trajectory corresponding to a current normalization lateral distance of the own vehicle that the current distance of the own vehicle in the lateral direction is normalized by the required lateral distance for the lane change;
by referring to the pattern of the target trajectory, calculates the normalization lateral distance of the target trajectory at each time point of current and future corresponding to the normalization traveling distance at each time point of current and future after the calculated current normalization traveling distance; and
generates the target trajectory for the lane change, using the calculated normalization lateral distance of the target trajectory at each time point of current and future, and the required lateral distance for the lane change.

10. The control calculation apparatus according to claim 4,
wherein the target trajectory generator corrects position of the destination lane of the lane change by the distance of the target trajectory in the lateral direction at each time point of current and future, and generates the target trajectory for the lane change.

11. The control calculation apparatus according to claim 1,
wherein the target trajectory generator uses a road width direction at each position of the destination lane of the lane change, as the lateral direction.

12. The control calculation apparatus according to claim 5,
wherein the target trajectory generator uses, as the pattern of the target trajectory, a polynomial in which the normalization time is set as an independent variable, and the normalization lateral distance of the target trajectory is set as a dependent variable.

13. The control calculation apparatus according to claim 12,
wherein, by defining the normalization time as Nt, and defining the normalization lateral distance of the target trajectory as Nwo, the target trajectory generator uses, as the pattern of the target trajectory,
Nwo=1−(6×Nt⁵−15×Nt⁴+10×Nt³).

14. The control calculation apparatus according to claim 5,
wherein the target trajectory generator sets the current distance of the own vehicle in the lateral direction with respect to the destination lane of the lane change at generation start of the target trajectory for the lane change, as the initial required lateral distance for the lane change; and
after the generation start, when the current distance of the own vehicle in the lateral direction exceeds the required lateral distance for the lane change which is set currently, the target trajectory generator sets the current distance of the own vehicle in the lateral direction, as the required lateral distance for the lane change.

15. The control calculation apparatus according to claim 1, further comprising:
a peripheral state acquisitor that acquires a peripheral state of the own vehicle; and
an entrance-forbidden area setter that sets an entrance-forbidden area where entrance of the own vehicle is forbidden, based on the peripheral state,
wherein, under a constraint condition that the own vehicle does not enter into the entrance-forbidden area, the control variable calculator calculates a target value of vehicle control variable for the own vehicle to travel along the target trajectory, based on the traveling state and the target trajectory.
